(19) United States
(12) Patent Application Publication
(10) Pub. No.: US 2026/0148383 A1
(43) Pub. Date: May 28, 2026

(54) GENERATING IMPLICIT NEURAL REPRESENTATIONS OF MEDICAL IMAGES

(71) Applicant: Elekta Limited, Crawley (GB)

(72) Inventors: Wenzhe Yin, Crawley (GB); Efstratios Gavves, Crawley (GB); Jan-Jakob Sonke, Amsterdam (NL)

(21) Appl. No.: 19/399,557

(22) Filed: Nov. 24, 2025

(30) Foreign Application Priority Data
Nov. 25, 2024 (GB) 2417256.1

(51) Int. Cl. G06T 7/00; G06N 3/047; G06N 3/09; G06N 20/00; G06T 7/35

(52) U.S. Cl. CPC G06T 7/0012; G06N 3/047; G06N 3/09; G06N 20/00; G06T 7/35; G06T 2207/10081; G06T 2207/10088; G06T 2207/20084

(57) ABSTRACT

A method for training a system to generate an Implicit Neural Representation INR of a 3D medical image is disclosed. The system comprises a first probabilistic ML module, a second probabilistic ML module, and a probabilistic Neural Radiance Field (NeRF) module. The method comprises, for individual training 3D medical images, generating context and target geometric bases using the first ML module, and generating prior and posterior distributions of a set of latent variables using the second probabilistic ML module. The method further comprises modulating the probabilistic NeRF module using values sampled from the prior distributions of the set of latent variables, and using the modulated probabilistic NeRF module to predict attenuation coefficient values for points sampled along ray paths from the training 3D medical image. The method further comprises updating trainable parameters of the first probabilistic ML module, second probabilistic ML module, and probabilistic NeRF module to minimize an objective function.

### CLAIM FOR PRIORITY

This application claims the benefit of priority of British Application No. 2417256.1, filed Nov. 25, 2024, which is hereby incorporated by reference in its entirety.

### TECHNICAL FIELD

The present disclosure relates to a method for training a system to generate an Implicit Neural Representation (INR) of a 3-dimensional (3D) medical image. The present disclosure also relates to a method for using a system to generate an INR of a 3D medical image. The present disclosure also relates to a training node, an image processing node, and to a computer program product configured, when run on a computer, to carry out methods for training and using a system to generate an INR of a 3D medical image.

### BACKGROUND

Implicit Neural Representations (INRs) are functions that encode a signal in a continuous manner. For example, in the case of a color image, an INR maps coordinates in the image to RGB values of the point in the image represented by the input coordinates. INRs thus respect the continuous nature of the underlying signal to be represented, as opposed to discretizing the signal, for example via a grid or point cloud. INRs have gained popularity for their ability to learn continuous, compact, and efficient representations of continuous signals, especially for 3D settings. Building on INRs, Neural Radiance Fields (NeRFs) model 3D scene representations as a mapping from 3D coordinates and view directions to color and density values. By integrating these values along camera rays, NeRFs can render photorealistic images of scenes.

### SUMMARY

Although NeRFs achieve good reconstruction performance, they must be overfitted to each 3D object or scene, resulting in poor generalization to new 3D scenes with few context images. Considering the example of medical images specifically, computed Tomography (CT) is a medical imaging technique for reconstructing material density inside a patient, using the mathematical and physical properties of X-ray scanners. In CT, several X-ray scans, or projections, of the patient are acquired from various angles using a detector, and various reconstruction methods can then be then used to create a three-dimensional image of the patient volume from the two-dimensional measurement data in the projections. To be precise, CT aims to produce attenuation coefficients of patient tissue, as they are strongly related to density under assumptions that hold in the CT setting. An important variant of CT is Cone Beam CT (CBCT), which uses flat panel detectors to scan a large fraction of the volume in a single rotation. CBCT reconstruction is more difficult than reconstruction for classical (helical) CT, owing to the inherent mathematical difficulty of Radon Transform inversion in the three-dimensional setting, physical limits of the detector, and characteristics of the measurement process such as noise.

INRs may offer particular advantages for the representation of medical images such as CT and CBCT images, owing to their ability to process data at an arbitrary resolution. For example, CT scans may result in different resolutions across different axes. In a conventional setting, this may be addressed by interpolating between slices for the axes with the lower resolution. However, with an INR that can be sampled an any resolution, this issue is completely avoided. Motivated by the advantages offered by INRs, recent works have shown promising results in performing deep learning tasks, such as classification and generation, directly on implicit representations. However, this new paradigm shift comes with significant challenges, not least of which is the time and computing resource required to fit a Neural Field, or Neural Radiance Field, to each individual CT or CBCT image.

Generalization of INRs is currently an open challenge. Previous works on INR generalization have approached the problem by gradient-based meta-learning to adapt to new scenes with a few optimization steps, modulating shared Multi-Layer Perceptrons (MLPs) through HyperNets, or directly predicting the parameters of scene-specific MLPs. However, the deterministic nature of these methods cannot account for the uncertainty of scenes or INR functions when only few partial observations are available, as may be the case.

To account for uncertainty induced by few available context images, probabilistic INR functions for NeRF have also been explored. These probabilistic methods, however, only approximate the INR functions in 3D space, neglecting the interaction between 3D functions and 2D observations, such as the 2D projections obtained in a CT or CBCT scan. As NeRFs model relationships in 3D space, with the only available context observations being 2D images, there is an information misalignment between contexts and functions in radiance field generalization.

An aim of the present disclosure can include providing methods, a training node, an image processing node, and a computer program product which at least partially address one or more of the challenges mentioned above. A further aim of the present disclosure can include providing methods, a training node, an image processing node, and a computer program product which cooperate to facilitate Neural Radiance Field generalization, and fast adaptation of an INR function for new 3D medical images using only a limited number of context image views.

According to a first aspect of the present disclosure, there is provided a computer implemented method for training a system to generate an Implicit Neural Representation (INR) of a 3-dimensional (3D) medical image. The system comprises a first probabilistic Machine Learning (ML) module, a second probabilistic ML module, and a probabilistic Neural Radiance Field (NeRF) module. The method comprises obtaining a training dataset comprising, for individual training 3D medical images,

a context set of ray paths and corresponding 2-dimensional (2D) projections of the image, and a target set of ray paths and corresponding 2D projections of the image. The target set comprises a greater number of ray paths and corresponding 2D projections of the image than the context set. The method further comprises, for individual training 3D medical images, performing the following steps (i) to (vi). Steps (i) and (ii) comprise generating a plurality of context geometric bases using the first probabilistic ML module and the context set, and generating a plurality of target geometric bases using the first probabilistic ML module and the target set. Step (iii) comprises generating prior distributions of a set of latent variables using the second probabilistic ML module, the context geometric bases, and points sampled along ray paths sampled from the training 3D medical image. Step (iv) comprises generating posterior distributions of the set of latent variables using the second probabilistic ML module, the target geometric bases, and the points sampled along ray paths sampled from the training 3D medical image.

Step (v) comprises modulating the probabilistic NeRF module using values sampled from the prior distributions of the set of latent variables. Step (vi) comprises using the modulated probabilistic NeRF module to predict attenuation coefficient values for points sampled along ray paths sampled from the training 3D medical image. The method further comprises updating trainable parameters of the first probabilistic ML module, second probabilistic ML module, and probabilistic NeRF module to minimize an objective function.

According to another aspect of the present disclosure, there is provided a computer implemented method for using a system to generate an INR of a 3D medical image. The system comprises a first probabilistic ML module, a second probabilistic ML module, and a probabilistic NeRF module. The method comprises obtaining a context set of ray paths and corresponding 2D projections of the image, and generating a plurality of context geometric bases using the first probabilistic ML module and the context set. The method further comprises generating prior distributions of a hierarchical set of latent variables using the second probabilistic ML module, the context geometric bases, and points sampled along ray paths sampled from the 3D medical image. The method further comprises modulating the probabilistic NeRF module using values sampled from the prior distributions of the hierarchical set of latent variables.

According to another aspect of the present disclosure, there is provided a computer program product comprising a computer readable non-transitory medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a training node for training a system to generate an INR of a 3D medical image. The system comprises a first probabilistic ML module, a second probabilistic ML module, and a probabilistic NeRF module. The training node comprises processing circuitry configured to cause the training node to obtain a training dataset comprising, for individual training 3D medical images, a context set of ray paths and corresponding 2D projections of the image, and a target set of ray paths and corresponding 2D projections of the image. The target set comprises a greater number of ray paths and corresponding 2D projections of the image than the context set. The processing circuitry is further configured to cause the training node to perform steps (i) to (vi) as described above for individual training 3D medical images. The processing circuitry is further configured to cause the training node to update trainable parameters of the first probabilistic ML module, second probabilistic ML module, and probabilistic NeRF module to minimize an objective function.

According to another aspect of the present disclosure, there is provided an image processing node for using a system to generate an INR of a 3D medical image. The system comprises a first probabilistic ML module, a second probabilistic ML module, and a probabilistic NeRF module. The image processing node comprises processing circuitry configured to cause the image processing node to obtain a context set of ray paths and corresponding 2D projections of the image, and to generate a plurality of context geometric bases using the first probabilistic ML module and the context set. The processing circuitry is further configured to cause the image processing node to generate prior distributions of a hierarchical set of latent variables using the second probabilistic ML module, the context geometric bases, and points sampled along ray paths sampled from the 3D medical image, and to modulate the probabilistic NeRF module using values sampled from the prior distributions of the hierarchical set of latent variables.

Aspects of the present disclosure thus provide methods and nodes that cooperate to provide an INR generalization for medical images. Example methods and nodes presented herein allow for the training of a system that is able to adapt rapidly to generate an INR of a new medical image using only limited observations. The observations may for example be in the form of a limited number of 2D projections of the image, such as may be available during acquisition of a medical image via CT or CBCT scanning, Magnetic Resonance imaging, etc. The INR can then be used for a range of downstream tasks to support the delivery of medical treatments such as radiotherapy. The generalization of the INR allows for the generation of an INR of a new medical image in reduced time, and with reduced computing power, when compared to training a new INR from scratch. In addition, example methods discussed herein allow for generation of the INR using only a limited number of 2D observations, as opposed to requiring a rich dataset of observations in order to generate the INR, as is the case for training a new INR from scratch.

Examples of the present disclosure may be implemented in digital electronic circuitry, or in computer hardware, firmware, software, or in combinations thereof. Examples of the present disclosure may be implemented as a computer program or a computer program product, i.e., a computer program tangibly embodied in a non-transitory information carrier, e.g., in a machine-readable storage device or in a propagated signal, for execution by, or to control the operation of, one or more hardware modules. A computer program may be in the form of a stand-alone program, a computer program portion, or more than one computer program, and may be written in any form of programming language, including compiled or interpreted languages, and it may be deployed in any form, including as a stand-alone program or as a module, component, subroutine, or other unit suitable for use in a data processing environment.

The disclosure is set out herein in terms of particular examples. Other examples, not explicitly described here, may nonetheless fall within the scope of the claims. Unless explicitly or implicitly specified otherwise, the steps of methods according to embodiments of the disclosure may be performed in a different order and still achieve desirable results.

### BRIEF DESCRIPTION OF THE DRAWINGS

For a better understanding of the present disclosure, and to show more clearly how it may be carried into effect, reference will now be made, by way of example, to the following drawings in which:

FIGS. 1A and 1B show examples of a flow chart illustrating process steps in a method for training a system to generate an INR of a 3D medical image;

FIGS. 2A to 2C show examples of a flow chart illustrating process steps in another example of a method for training a system to generate an INR of a 3D medical image;

FIG. 3 is an example of a flow chart illustrating process steps in a method for using a system to generate an INR of a 3D medical image;

FIGS. 4A and 4B show examples of a flow chart illustrating process steps in another example of a method for using a system to generate an INR of a 3D medical image

FIG. 5 illustrates examples of functional modules in a training node;

FIG. 6 illustrates examples of functional modules in an image processing node;

FIG. 7 illustrates an example of a volume rendering technique;

FIG. 8 illustrates an example of a Geometric Neural Processes implementation;

FIG. 9 shows an example of a graphical model of a Geometric Neural Process;

FIG. 10 presents Table 1, showing experimental results;

FIG. 11 presents Table 2, showing experimental results; and

FIG. 12 presents Table 3, showing experimental results.

### DETAILED DESCRIPTION

Examples of the present disclosure provide methods that allow generation of INRs of new medical images using only a few 2D observations of the image, for example in the form of 2D projections of a CT or CBCT scan of a patient. The methods achieve probabilistic radiance field generalization using Geometric Neural Processes (GeomNP). To achieve this generalization, examples of the resent disclosure use a probabilistic NeRF generalization framework, in which radiance field generalization is cast as a probabilistic modeling problem. In this manner, the probabilistic model can be amortized over multiple objects with few views, facilitating the learning and generalization of NeRF functions. In order to eliminate the potential information misalignment between 2D observations of the 3D image, examples of the present disclosure encode the observations in 2D space using 3D prior structures. The resulting geometric bases can aggregate locality information to each 3D point, improving the exploration of high-frequency details. In some examples, Geometric neural processes with hierarchical latent variables may be used, with geometric neural processes, based on the geometric bases, capturing the uncertainty in the latent NeRF function space. Specifically, in some examples, hierarchical latent variables may be used to modulate the INR function at multiple spatial levels, yielding improved generalization on new images and new projections. As is discussed in greater detail at the end of the present disclosure, experiments on novel view synthesis of ShapeNet objects and real-world DTU scenes using an implementation of the methods disclosed herein demonstrate the effectiveness of these methods on 3D radiance field generalization. It will also be appreciated that the proposed methods can seamlessly apply to INR generalization in 2D signals (images).

In order to provide additional context for the methods disclosed herein, there now follows a brief discussion of Neural Processes. Neural Processes (NPs), as disclosed in Marta Garnelo, Jonathan Schwarz, Dan Rosenbaum, Fabio Viola, Danilo J Rezende, SM Eslami, and Yee Whye Teh: “Neural processes”, arXiv preprint arXiv:1807.01622, 2018b, are a meta-learning framework that characterizes distributions over functions, enabling probabilistic inference, rapid adaptation to novel observations, and the capability to estimate uncertainties. This framework is divided into two classes of research. The first class concentrates on the marginal distribution of latent variables, and the second targets the conditional distributions of functions given a set of observations. Typically, a Multi-Layer Perceptron (MLP) is employed in Neural Processes methods. Attentive Neural Processes integrate the attention mechanism to improve the representation of individual context points. As discussed in the Background section, the Versatile Neural Process (VNP) (Guo et al., 2023) employs attentive neural processes for neural field generalization, but does not consider the information misalignment between the 2D context set and the 3D target points.

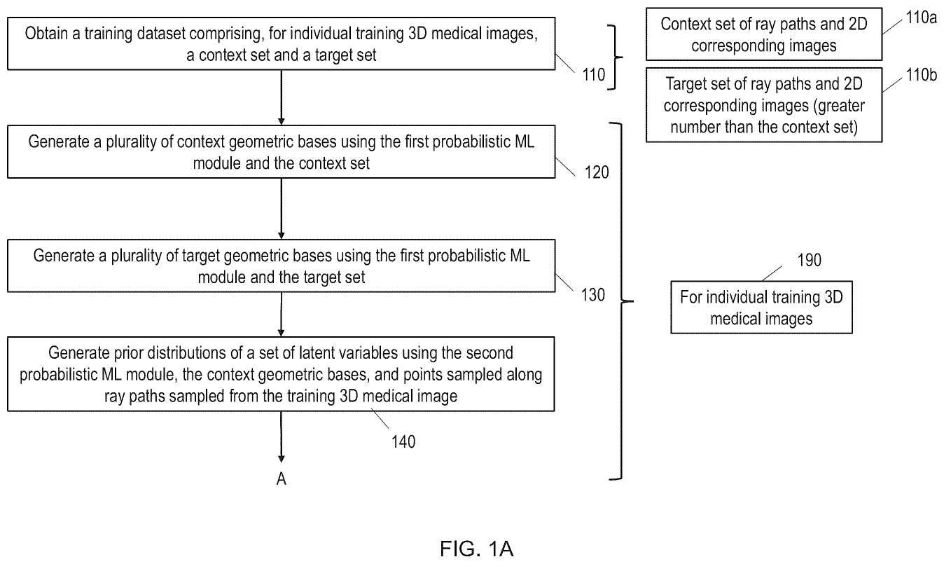

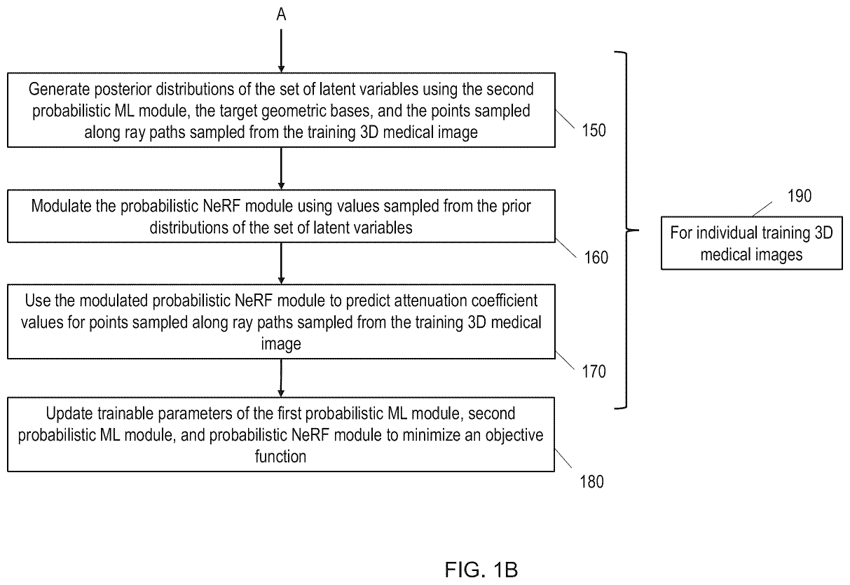

FIGS. 1A and 1B show a flow chart illustrating process steps in a computer implemented method 100 for training a system to generate an INR of a 3D medical image. The system comprises a first probabilistic ML module, a second probabilistic ML module, and a probabilistic NeRF module. The method may be performed by a training node, which may comprise a physical or virtual node, and may be implemented in a computer system, imaging apparatus, treatment apparatus, such as a radiotherapy treatment apparatus, computing device, or server apparatus, and/or may be implemented in a virtualized environment, for example in a cloud, edge cloud, or fog deployment. Examples of a virtual node may include a piece of software or computer program, a code fragment operable to implement a computer program, a virtualised function, or any other logical entity. The training node may encompass multiple logical entities, as discussed in greater detail below.

Referring first to FIG. 1A, the method 100 first comprises, in step 110, obtaining a training dataset. As illustrated at 110a and 110b, the training dataset comprises, for individual training 3D medical images, a context set of ray paths and corresponding 2D projections of the image, and a target set of ray paths and corresponding 2D projections of the image. As illustrated at 110b, the target set comprises a greater number of ray paths and corresponding 2D projections of the image than the context set. The target set thus provides a richer and more complete representation of the training image than the context set. The difference between the number of ray paths and corresponding 2D projections in the context and target sets may vary. In some examples, the context set may contain only a very limited number, such as between 1 and 600 ray paths and corresponding 2D projections, while the target set may contain between 600 and 3000 or more ray paths and corresponding 2D projections.

Following step 110, the method 100 then comprises performing each of steps 120 to 170 for individual training 3D medical images represented in the obtained training dataset, as illustrated at step 190.

In step 120, the method comprises generating a plurality of context geometric bases using the first probabilistic ML module and the context set for the relevant training image. In step 130, the method comprises generating a plurality of target geometric bases using the first probabilistic ML module and the target set. The first probabilistic ML module is thus used to encode the observations in the context and target sets by generating geometric bases from inputs comprising the observations in the relevant set. In step 140, the method 100 comprises generating prior distributions of a set of latent variables using the second probabilistic ML module, the context geometric bases, and points sampled along ray paths sampled from the training 3D medical image.

Referring now to FIG. 1B, in step 150, the method 100 comprises generating posterior distributions of the set of latent variables using the second probabilistic ML module, the target geometric bases, and the points sampled along ray paths sampled from the training 3D medical image. The generated geometric bases are therefore used as input to the second probabilistic ML module, together with points sampled along ray paths sampled from the relevant training image, to generate prior and posterior distributions of latent variables. The generated distributions of the latent variables consequently include the 3D information from the geometric bases, via the action of the second probabilistic ML module. In step 160, the method comprises modulating the probabilistic NeRF module using values sampled from the prior distributions of the set of latent variables. In step 170, the method 100 comprises using the modulated probabilistic NeRF module to predict attenuation coefficient values for points sampled along ray paths sampled from the training 3D medical image. Having performed steps 120 to 170 for individual training images, the method 100 then comprises updating trainable parameters of the first probabilistic ML module, second probabilistic ML module, and probabilistic NeRF module to minimize an objective function. As discussed in greater detail below with reference to the method 200, the objective function may comprise components representing a reconstruction loss of the modulated probabilistic NeRF module, and divergences between the context and geometric bases, and between the prior and posterior distributions of the set of latent variables. The reconstruction loss and divergences may be calculated on the basis of the outputs of steps 120, 130, 140, 150, and 170 of the method 100, as conducted for the different training 3D medical images.

The method 100 thus enables training of a generalized system for generation of INRs of medical images. The system is generalised in that the probabilistic NeRF module can be adapted, through modulation, to represent a new medical image using only a limited number of observations, these observations being contained in a context set for the new image. This process is demonstrated in the later discussion of methods 300 and 400. The geometric bases generated from the context and target sets in the method 100 encode 3D structural information, thus addressing the information misalignment between 2D observations and the 3D medical image represented by the NeRF functions in the probabilistic NeRF module. The latent variables in the method 100 integrate the geometric information from the geometric bases, to provide improved modulation of the NeRF for a new medical image. The use of the target and context sets in the training of the method 100 provides knowledge transfer from the richer representation provided by the target set. It will be appreciated that the first and second probabilistic ML modules each comprise a shared ML architecture, each module being used for both the context and target sets. In this manner, it is ensured that the trained architecture for generating both the geometric bases (first probabilistic ML module) and the latent variables (second probabilistic ML module) learns to take account not just of the limited information available in a new context set, but is also operable to use information from the richer and more complete representations of the training images contained in the target sets. Consequently, the trained architecture is able to generate an INR of a new image based on just a few projections of the new image, as opposed to the extensive training from scratch that is required to generate an INR of a new image in a conventional manner. Examples of the method 100 thus achieve a generalized NeRF architecture for generation of INRs of medical images, offering the adaptability and data flexibility of geometric processes, combined with the computational efficiency of neural networks.

It will be appreciated that following obtaining of the training dataset, the subsequent steps of the method 100 may be repeated until a convergence condition is satisfied. The convergence condition may include any number of factors, including a value of the objective function or its evolution with method iteration, a training time, and size or amount of the obtained training dataset, etc. It will also be appreciated that according to some examples of the present disclosure, the training 3D medical images may be images of corresponding anatomical regions of different patients.

The method 100 is for training a system comprising a first probabilistic ML moule, a second probabilistic ML module, and a probabilistic NeRF module. Each of these modules may comprise one or more Machine Learning (ML) models. For the purposes of the present disclosure, the term “ML model” encompasses within its scope the following concepts:
machine Learning algorithms, comprising processes or instructions through which data may be used in a training process to generate a model artefact for performing a given task, or for representing a real-world process or system; and
the model artefact that is created by such a training process, and which comprises the computational architecture that performs the task.

As discussed above, step 160 of the method 100 comprises modulating the probabilistic NeRF module of the system being trained. Modulation refers to a process in which the computation carried out by an ML model is conditioned, or influenced, by information extracted from an auxiliary source. The conditioning may take the form of one or more transformations applied to a model, for example to the weights or activations of a neural network. In the method 100, the auxiliary source for modulation is the prior distributions of the set of latent variables, generated in step 140.

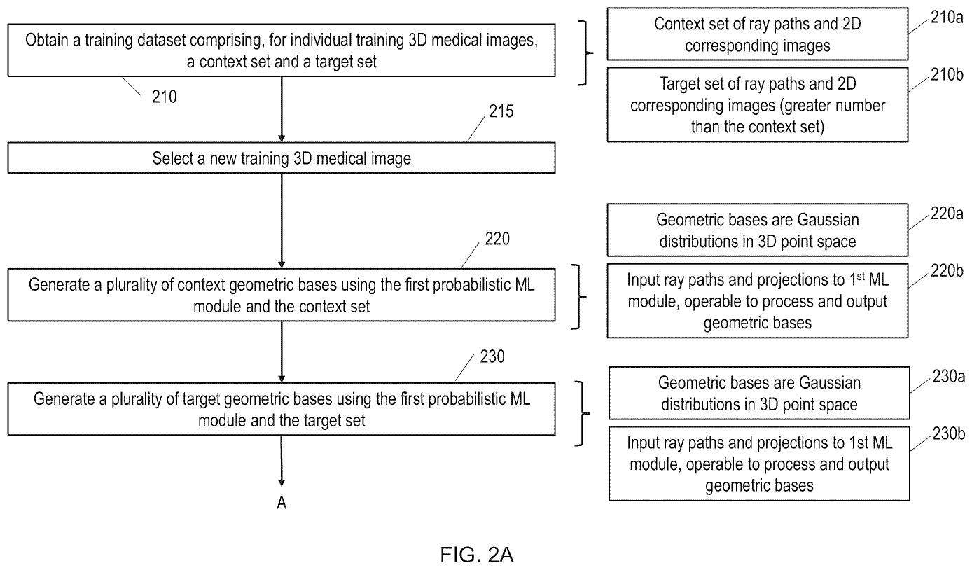

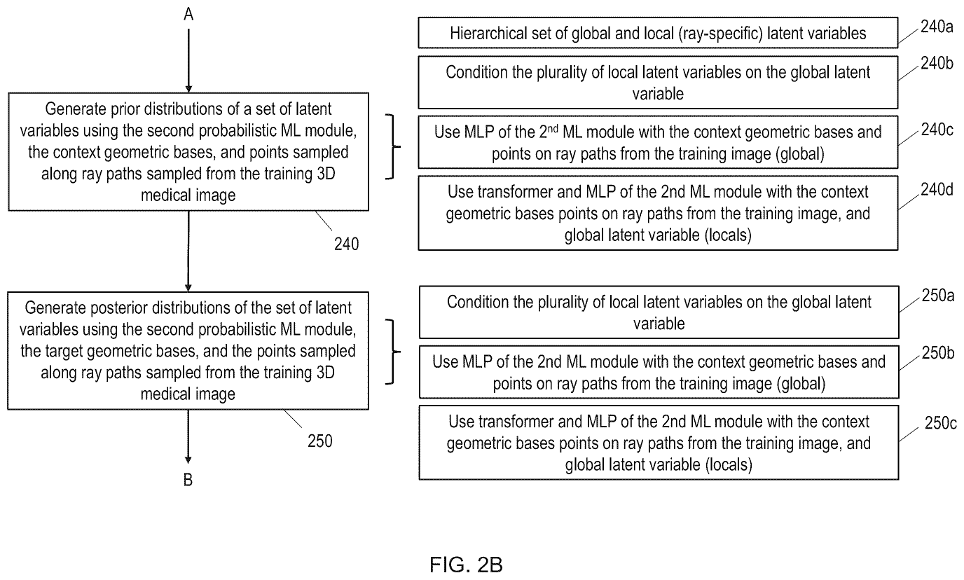

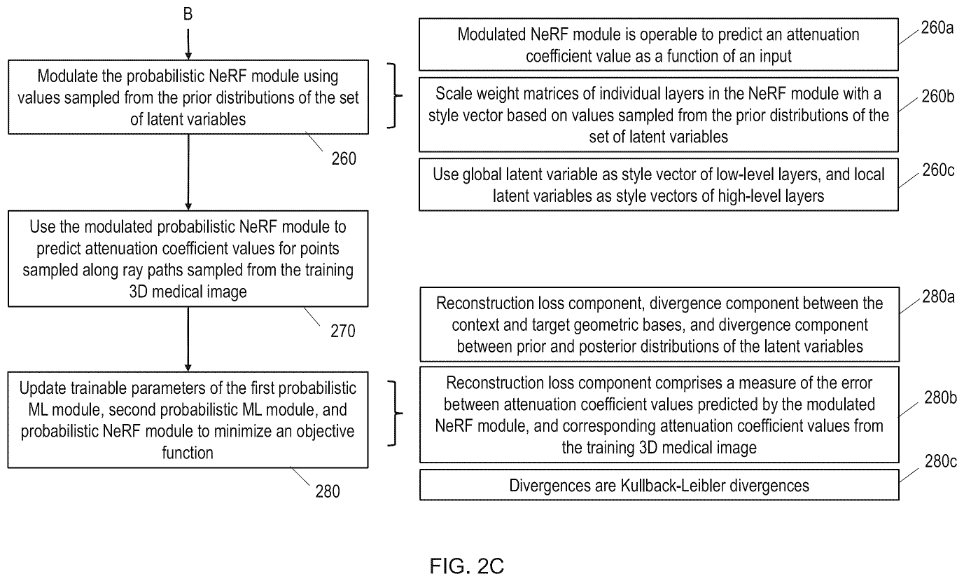

FIGS. 2A to 2C show flow charts illustrating a further example of a method 200 for training a system to generate an INR of a 3D medical image. As for the method 100 discussed above, the method 200 may be performed by a training node, which may comprise a physical or virtual node, and may be implemented in a computer system, imaging apparatus, treatment apparatus, such as a radiotherapy treatment apparatus, computing device, or server apparatus, and/or may be implemented in a virtualized environment, for example in a cloud, edge cloud, or fog deployment. Examples of a virtual node may include a piece of software or computer program, a code fragment operable to implement a computer program, a virtualised function, or any other logical entity. The training node may encompass multiple logical entities, as discussed in greater detail below. The method 200 illustrates an example of how the steps of the method 100 may be implemented and supplemented to provide the above discussed and additional functionality.

As for the method 100 discussed above, the system trained according to the method 200 comprises a first probabilistic ML module, a second probabilistic ML module, and a probabilistic NeRF module. In some examples of the method 200, the first probabilistic ML module may comprise a self-attention module and a Multi-Layer Perceptron (MLP). In further examples of the method 200, the second probabilistic ML module may comprise a transformer module and an MLP.

Referring initially to FIG. 2A, according to examples of the method 200, the training first obtains a training dataset at step 210. As illustrated at 210a and 210b, the training set comprises, for individual training 3D medical images, a context set of ray paths and corresponding 2D projections of the image, and a target set of ray paths and corresponding 2D projections of the image. As illustrated at 210b, the target set comprises a greater number of ray paths and corresponding 2D projections of the image than the context set. The target set may thus be understood as providing a more complete representation of the relevant training image than the corresponding context set of the image. The training 3D medical images may comprise at least one of Computed Tomography (CT) images, Cone Beam CT (CBCT) images and/or Magnetic Resonance (MR images.

The method 200 then comprises performing the steps 220 to 270 for individual training 3D medical images. At step 215, the training node selects a next training image for processing. In step 220, the training node generates a plurality of context geometric bases using the first probabilistic ML module and the context set of the selected image. As illustrated at 220a, according to examples of the present disclosure, the geometric bases comprise Gaussian distributions in 3D point space. The geometric bases may in some examples also comprise corresponding semantic representations. As illustrated at 220b, generating the plurality of context geometric bases using the first probabilistic ML module and the context set may comprise inputting the ray paths and corresponding 2D projections of the context set to the first probabilistic ML module. The first probabilistic ML module is operable to process the ray paths and corresponding 2D projections in accordance with current values of its trainable parameters, and to output the plurality of context geometric bases. In some examples, processing of the ray paths and corresponding 2D projections of the context set by the first probabilistic ML module may first comprise concatenating the contents of the context set, and then splitting the concatenated contents of the context set into visual tokens. Processing may then comprise using a linear layer and a self-attention module of the first probabilistic ML module to project each token into a multi-dimensional vector, and then predicting the same number of bases as there are tokens, using two MLP modules of the first probabilistic ML module: the first MLP module for generating 3D Gaussian distribution parameters, the second for generating the multidimensional latent representation.

In step 230, the training node generates a plurality of target geometric bases using the first probabilistic ML module and the target set. As discussed above and illustrated at 230a, the geometric bases may comprise Gaussian distributions in 3D point space, and may also comprise corresponding semantic representations. Also as discussed above, and as illustrated at 230b, generating the plurality of target geometric bases using the first probabilistic ML module and the target set may comprise inputting the ray paths and corresponding 2D projections of the target set to the first probabilistic ML module. The first probabilistic ML module is operable to process the ray paths and corresponding 2D projections in accordance with current values of its trainable parameters, and to output the plurality of context geometric bases. The first probabilistic module is used for generation of both the context and target geometric bases, and consequently the processing of the target set by the first probabilistic ML module may be substantially as discussed above for the context set.

Referring now to FIG. 2B, in step 240, the training node generates prior distributions of a set of latent variables using the second probabilistic ML module, the context geometric bases, and points sampled along ray paths sampled from the training 3D medical image. As illustrated at 240a, the set of latent variables may comprise a hierarchical set, and may include a global level latent variable and a plurality of local latent variables. The plurality of local latent variables may comprise ray specific latent variables. In some examples, generating the distributions for the ray specific latent variables may comprise using points sampled along the relevant ray.

As illustrated at 240b, generating the prior distributions of the set of latent variables using the second probabilistic ML module, the context geometric bases, and points sampled along ray paths sampled from the training 3D medical image, may comprise conditioning the plurality of local latent variables on the global latent variable. In further examples, as illustrated at 240c, generating the prior distributions of the global latent variable may comprise using an MLP of the second probabilistic ML module with the context geometric bases and points sampled along ray paths sampled from the training 3D medical image. In some examples, multiple MLPs may be used in generating the prior distributions. As illustrated at 240d, generating the prior distributions of the local latent variables may comprise using a transformer and MLP of the second probabilistic ML module with the context geometric bases, points sampled along ray paths sampled from the training 3D medical image, and the global latent variable.

In step 250, the training node generates posterior distributions of the set of latent variables using the second probabilistic ML module, the target geometric bases, and the points sampled along ray paths sampled from the training 3D medical image; As illustrated at 250a, generating the posterior distributions of the set of latent variables using the second probabilistic ML module, the target geometric bases, and points sampled along ray paths sampled from the training 3D medical image, may comprise conditioning the plurality of local latent variables on the global latent variable. In further examples, as illustrated at 250b, generating the posterior distributions of the global latent variable may comprise using an MLP of the second probabilistic ML module with the target geometric bases and points sampled along ray paths sampled from the training 3D medical image. In some examples, multiple MLPs may be used in generating the posterior distributions. As illustrated at 250c, generating the posterior distributions of the local latent variables may comprise using a transformer and MLP of the second probabilistic ML module with the target geometric bases, points sampled along ray paths sampled from the training 3D medical image, and the global latent variable.

Referring now to FIG. 2C, in step 260, the training node modulates the probabilistic NeRF module using values sampled from the prior distributions of the set of latent variables. As illustrated at 260a, the modulated probabilistic NeRF module may be operable to predict an attenuation coefficient value as a function of an input comprising three dimensional spatial coordinates of a location for the prediction and a ray path direction for the prediction. In some examples of the present disclosure, the probabilistic NeRF module may be implemented with an architecture comprising two modulated layers and two shared layers.

As illustrated at 260b, modulating the probabilistic NeRF module using values sampled from the prior distributions of the set of latent variables may comprise scaling weight matrices of individual layers in the probabilistic NeRF module with a style vector based on values sampled from the prior distributions of the set of latent variables. In some examples, as illustrated at 260c, modulating the probabilistic NeRF module using values sampled from the prior distributions of the set of latent variables may comprise using the global latent variable as style vector of low-level layers of the probabilistic NeRF module, and the plurality of local latent variables as style vectors of the high-level layers of the probabilistic NeRF module.

Following modulation, in step 270, the training node then uses the modulated probabilistic NeRF module to predict attenuation coefficient values for points sampled along ray paths sampled from the training 3D medical image.

In step 280, the training node updates trainable parameters of the first probabilistic ML module, second probabilistic ML module, and probabilistic NeRF module to minimize an objective function. As discussed above and illustrated at 280a, the objective function may comprise a reconstruction loss component, a component of divergence between the context and geometric bases, and a component of divergences between the prior and posterior distributions of the set of latent variables. In some examples, as illustrated at 280b, the reconstruction loss component may comprise a measure of the error between the attenuation coefficient values for points sampled along ray paths sampled from the training 3D medical image predicted by the modulated probabilistic NeRF module, and corresponding attenuation coefficient values for the points extracted from the training 3D medical image. The reconstruction loss component may therefore provide a measure of the accuracy of the representation of the image provided by the modulated probabilistic NeRF module.

In further examples, as illustrated at 280c, the divergence between the context and geometric bases, and the divergences between the prior and posterior distributions of the set of latent variables may comprise Kullback-Leibler divergences. An example objective function (Equation 10) is provided later in the present disclosure, in the context of an example implementation of the methods presented herein. It will be appreciated that by including not only a reconstruction loss component, but also divergences between target and context geometric basis and prior and posterior distributions of the set of latent variables, examples of the objective function not only promote reconstruction accuracy, but ensure a knowledge transfer from the rich representation of the training medical image provided by the target set. By minimising divergence between elements based on the target and context sets, the objective function trains the architecture to extract a maximum of information about a medical image from just the representation provided by the context set.

In some examples of the present disclosure, the steps 220 to 270 of the method 100 may be repeated for several iterations, corresponding to several training medical images, before the step 280 of carrying out updating of the trainable parameters of the ML and NeRF modules is performed. In other examples, all of steps 220 to 280 may be carried out image by image. A convergence criterion may be used to determine at what point to stop iteration of the method 200, and this convergence criterion may be checked for example after updating of the trainable parameters in step 280. The convergence criterion may take any appropriate form, and may include one or more conditions, including for example consideration of all available training medical images, a condition based on evolution of the calculated value of the objective function, a time based criterion, etc. whether all images have been considered/convergence criterion.

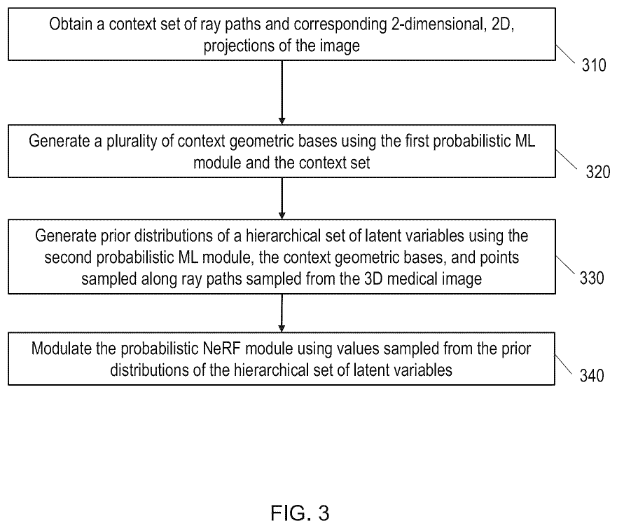

The methods 100 and 200, for training a system to generate an INR of a 3D medical image, may be complemented by a method 300 for using a system to generate an INR of a 3D medical image, as illustrated in FIG. 3. The method 300 thus relates to use at inference of a system such as that discussed above. As for the methods 100 and 200, the system of the method 300 comprises a first probabilistic ML module, a second probabilistic ML module, and a probabilistic NeRF module. The method 300 may be performed by an image processing node, which may comprise a physical or virtual node, and may be implemented in a computer system, imaging apparatus, treatment apparatus, such as a radiotherapy treatment apparatus, computing device, or server apparatus, and/or may be implemented in a virtualized environment, for example in a cloud, edge cloud, or fog deployment. Examples of a virtual node may include a piece of software or computer program, a code fragment operable to implement a computer program, a virtualised function, or any other logical entity. The image processing node may encompass multiple logical entities, as discussed in greater detail below.

FIG. 3 is a flow chart illustrating process steps in the example method 300. Referring to FIG. 3, in a first step 310, the method 300 comprises obtaining a context set of ray paths and corresponding 2D projections of the image for which an INR is to be generated. In step 320, the method comprises generating a plurality of context geometric bases using the first probabilistic ML module of the system and the context set. The method then comprises, in step 330, generating prior distributions of a hierarchical set of latent variables using the second probabilistic ML module, the context geometric bases, and points sampled along ray paths sampled from the 3D medical image. Finally, the method 300 comprises modulating the probabilistic NeRF module using values sampled from the prior distributions of the hierarchical set of latent variables. The modulated NeRF provides the INR of the medical image, enabling attenuation coefficient values at any part of the image to be generated with an input of position location and ray direction. It will be appreciated that, as discussed in greater detail below, the system used in the method 300 may have been trained using examples of the methods 100 and/or 200, in which example, the system architecture trained as set out above is used in the method 300 to generate an INR of a medical image using only the representation available from the context set. Also as discussed above, and in further detail below, the context set may contain only a limited number of ray paths and corresponding 2D projections. In some examples, the context set may contain between 1 and 600 ray paths and corresponding 2D projections,

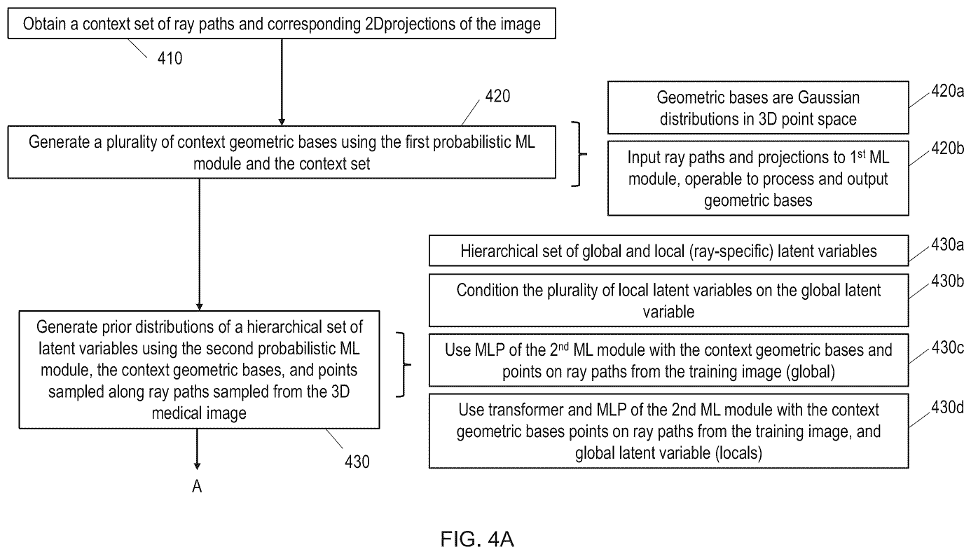

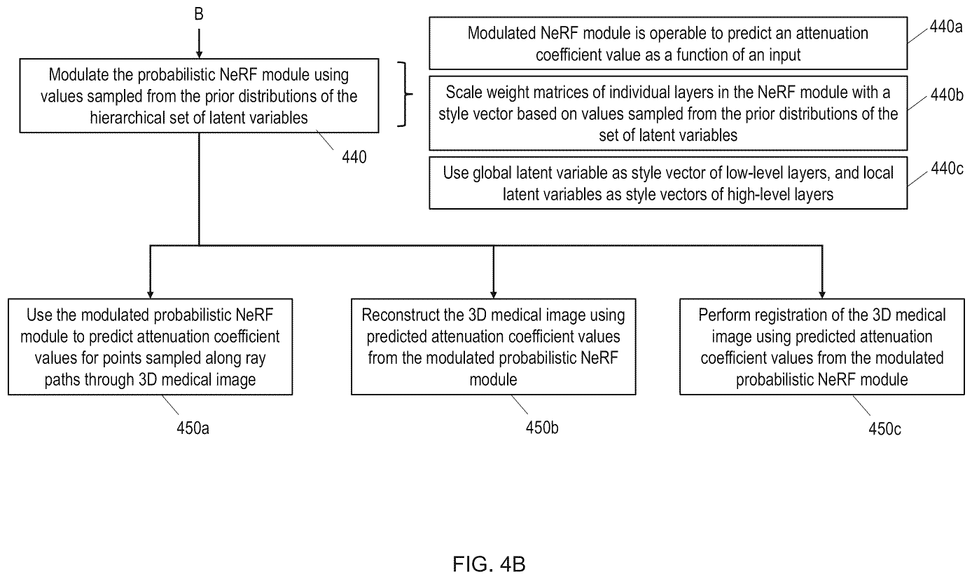

FIGS. 4A and 4B show flow charts illustrating a further example of a method 400 for using a system to generate an INR of a 3D medical image. As for the method 300 discussed above, the method 400 may be performed by an image processing node, which may comprise a physical or virtual node, and may be implemented in a computer system, imaging apparatus, treatment apparatus, such as a radiotherapy treatment apparatus, computing device, or server apparatus, and/or may be implemented in a virtualized environment, for example in a cloud, edge cloud, or fog deployment. Examples of a virtual node may include a piece of software or computer program, a code fragment operable to implement a computer program, a virtualised function, or any other logical entity. The image processing node may encompass multiple logical entities, as discussed in greater detail below. The method 400 illustrates an example of how the steps of the method 300 may be implemented and supplemented to provide the above discussed and additional functionality.

As for the method 300 discussed above, the system used in the method 400 comprises a first probabilistic ML module, a second probabilistic ML module, and a probabilistic NeRF module. In some examples of the method 400, the first probabilistic ML module may comprise a self-attention module and a Multi-Layer Perceptron (MLP). In further examples of the method 400, the second probabilistic ML module may comprise a transformer module and an MLP.

In some examples of the method 400, the system is a trained system, and has been trained using examples of the method 100 and/or 200 as described above.

In some examples of the method 400, the medical image for which an INR is generated may comprise at least one of a Computed Tomography (CT) image, a Cone Beam CT (CBCT) image, and/or a Magnetic Resonance Image. As discussed above, the system used in the method 400 may have been trained using examples of the method 100 and/or 200, and the training images used for training of the system may be images of corresponding anatomical regions of different patients. According to some examples of the method 400, the image for which an INR is generated according to the method 400 may comprise an image of an anatomical region of a patient that is the same as, or corresponds to, the anatomical region illustrated in the images used to train the system. Corresponding anatomical regions of different patient may comprise regions including substantially the same or overlapping anatomical structures.

Referring initially to FIG. 4A, according to examples of the method 400, the image processing node first obtains a context set of ray paths and corresponding 2D projections of the image in step 410. As discussed above with reference to the method 300, the context set may in some examples contain a relatively limited number of ray paths and corresponding projections, which may represent a fraction of the number of ray paths and corresponding projections that would normally be generated during the course of image acquisition. In some examples, the context set may contain between 1 and 600 ray paths and corresponding 2D projections. In step 420, the image processing node generates a plurality of context geometric bases using the first probabilistic ML module and the context set. As illustrated at 420a, according to examples of the present disclosure, the geometric bases comprise Gaussian distributions in 3D point space. The geometric bases may in some examples also comprise corresponding semantic representations.

As illustrated at 420b, generating the plurality of context geometric bases using the first probabilistic ML module and the context set may comprise inputting the ray paths and corresponding 2D projections of the context set to the first probabilistic ML module. The first probabilistic ML module is operable to process the ray paths and corresponding 2D projections in accordance with current values of its trainable parameters, and to output the plurality of context geometric bases. In some examples, processing of the ray paths and corresponding 2D projections of the context set by the first probabilistic ML module may first comprise concatenating the contents of the context set, and then splitting the concatenated contents of the context set into visual tokens. Processing may then comprise using a linear layer and a self-attention module of the first probabilistic ML module to project each token into a multi-dimensional vector, and then predicting the same number of bases as there are tokens, using two MLP modules of the first probabilistic ML module: the first MLP module for generating 3D Gaussian distribution parameters, the second for generating the multidimensional latent representation.

In step 430, the image processing node generates prior distributions of a set of latent variables using the second probabilistic ML module, the context geometric bases, and points sampled along ray paths sampled from the 3D medical image. As illustrated at 430a, the set of latent variables may comprise a hierarchical set, and may include a global level latent variable and a plurality of local latent variables. The plurality of local latent variables may comprise ray specific latent variables. In some examples, generating the distributions for the ray specific latent variables may comprise using points sampled along the relevant ray.

As illustrated at 430b, generating the prior distributions of the set of latent variables using the second probabilistic ML module, the context geometric bases, and points sampled along ray paths sampled from the 3D medical image, may comprise conditioning the plurality of local latent variables on the global latent variable. In further examples, as illustrated at 430c, generating the prior distributions of the global latent variable may comprise using an MLP of the second probabilistic ML module with the context geometric bases and points sampled along ray paths sampled from the 3D medical image. In some examples, multiple MLPs may be used in generating the prior distributions. As illustrated at 430d, generating the prior distributions of the local latent variables may comprise using a transformer and MLP of the second probabilistic ML module with the context geometric bases, points sampled along ray paths sampled from the 3D medical image, and the global latent variable.

Referring now to FIG. 4B, in step 440, the image processing node modulates the probabilistic NeRF module using values sampled from the prior distributions of the set of latent variables. As illustrated at 440a, the modulated probabilistic NeRF module may be operable to predict an attenuation coefficient value as a function of an input comprising three dimensional spatial coordinates of a location for the prediction and a ray path direction for the prediction. In some examples of the present disclosure, the probabilistic NeRF module may be implemented with an architecture comprising two modulated layers and two shared layers.

As illustrated at 440b, modulating the probabilistic NeRF module using values sampled from the prior distributions of the set of latent variables may comprise scaling weight matrices of individual layers in the probabilistic NeRF module with a style vector based on values sampled from the prior distributions of the set of latent variables. In some examples, as illustrated at 440c, modulating the probabilistic NeRF module using values sampled from the prior distributions of the set of latent variables may comprise using the global latent variable as style vector of low-level layers of the probabilistic NeRF module, and the plurality of local latent variables as style vectors of high-level layers of the probabilistic NeRF module.

In steps 450a, 450b and/or 450c, the image processing node uses the modulated NeRF module. In step 450a, the image processing node uses the modulated probabilistic NeRF module to predict attenuation coefficient values for points sampled along ray paths through the 3D medical image. In step 450b, the image processing node reconstructs the 3D medical image using predicted attenuation coefficient values from the modulated probabilistic NeRF module. In step 450c, the image processing node performs registration of the 3D medical image using predicted attenuation coefficient values from the modulated probabilistic NeRF module. Steps 450a, 450b, and 450c thus illustrate different ways in which the INR provided by the modulated NeRF module may be used by the image processing node, to predict attenuation coefficients so as to allow for a reconstruction of the 3D medical image, and/or to perform additional image processing of the image, such as for example image registration. In further examples, additional image processing tasks may be performed for the 3D medical image by performing the tasks using the INR provided by the modulated NeRF module, as opposed to performing the tasks directly on the reconstructed 3D image. In some examples, the image processing tasks may be performed using ML architectures.

Examples of the methods 100, 200, 300 and/or 400 thus address the challenge of INR generalization, providing a system that can adapt quickly to new signals (new images) with limited observations contained in a context set. By formulating INR generalization probabilistically, the methods disclosed herein incorporate uncertainty, and directly infer INR function distributions from limited context images. To mitigate the information alignment between 2D context images and 3D discrete points, the methods introduce geometric bases, which learn to provide structured geometric information of the 3D image. Moreover, the hierarchical neural process modeling enables both object-specific and ray-specific modulation of the INR function. In practice, the proposed methods may also be applied to 2D INR generalization problems.

By providing a generalizable INR framework, and so avoiding full training from scratch in order to generate an INR for a new medical image, example methods according to the present disclosure significantly reduce the time required for generating an INR of a new medical image.

An important use for medical images is in the planning and delivery of Radiotherapy, which may be used to treat cancers or other conditions in human or animal tissue. The treatment planning procedure for radiotherapy may include using a 3D image of the patient to identify a target region, for example the tumour, and to identify organs near the tumour, termed Organs at Risk (OARs). A treatment plan aims to ensure delivery of a required dose of radiation to the tumour, while minimising the risk to nearby OARs. A treatment plan for a patient may be generated in an offline manner, using medical images that have been obtained using, for example classical CT. These images are generally referred to in this context as diagnostic or planning CT images. The radiation treatment plan includes parameters specifying the direction, cross sectional shape, and intensity of each radiation beam to be applied to the patient. The radiation treatment plan may include dose fractioning, in which a sequence of radiation treatments is provided over a predetermined period of time, with each treatment delivering a specified fraction of the total prescribed dose. Multiple patient images may be required during the course of radiotherapy treatment, and owing to their speed, convenience, and lower cost, CBCT images, as opposed to classical CT images, may be used to determine changes in patient anatomy between delivery of individual dose fractions.

Analysis of CT and CBCT images for the development and delivery of a radiotherapy treatment plan has been enhanced with Machine Learning, with the aim of improving accuracy and repeatability, and reducing the clinician time required for this process. Analysis tasks for which ML techniques have been explored include image reconstruction, scatter, noise and artifact reduction, image segmentation, image registration, etc. Performing such ML tasks on INRs as opposed to standard arrays representing the CT or CBCT scans, can offer particular advantages, as discussed below.

According to existing techniques for performing ML tasks on CT or CBCT images, it is first necessary to use traditional reconstruction methods in order to generate reconstructed images from the measurement data captured in the 2D projections of a patient. These reconstructed images are then used as input to the ML model for performing the downstream ML task, such as segmentation of a target tumor and nearby organs at risk, image registration, etc. Traditional reconstruction methods address the inverse problem of obtaining a reconstructed patient volume from the measured intensity values present in projection data. In contrast, when fitting an INR to a medical image, the process of fitting the INR effectively models the data acquisition process, i.e., the INR models the process by which X-rays are attenuated by the patient volume, with this modeling being supervised by the obtained measurements. Medical images encoded with INRs ae thus inherently more explicitly representative of the underlying patent volume than arrays representing a reconstructed image, in addition to being able to handle data sampled at different resolutions. It may consequently be inferred that downstream ML tasks performed on the more explicit representation of the patient volume that is provided by INRs will result in improved performance. In addition, INRs can be used to generate a reconstructed image, on which downstream ML tasks may then be performed.

The time and computing resources required to train an INR from scratch for a new medical image have hindered the adoption of INRs into radiotherapy treatment planning and delivery workflows. The provision, according to the present disclosure, of a generalizable architecture for generating INRs quickly based on only a limited number of projections in a context set, can therefore ensure that INRs become a viable option for radiotherapy workflows. The speed at which a new INR can be generated using the methods disclosed herein can support real-time or near real-time scenarios and applications, bringing the advantages of INRs to the planning and delivery of radiotherapy. The technical benefits of this provision include reduced radiotherapy treatment plan creation time, and may result in many additional medical treatment benefits (including improved accuracy of radiotherapy treatment, reduced exposure to unintended radiation, reduced treatment duration, etc.). The methods presented herein may be applicable to a variety of medical treatment and diagnostic settings or radiotherapy treatment equipment and devices.

As discussed above, the methods 100 and 200 presented herein may be performed by a training node, and the present disclosure provides a training node that is adapted to perform any or all of the steps of the above discussed methods. The training node may comprise a physical or virtual node, and may be implemented in a computer system, treatment apparatus, such as a radiotherapy treatment apparatus, computing device, or server apparatus, and/or may be implemented in a virtualized environment, for example in a cloud, edge cloud, or fog deployment. Examples of a virtual node may include a piece of software or computer program, a code fragment operable to implement a computer program, a virtualised function, or any other logical entity. The training node may encompass multiple logical entities, as discussed in greater detail below.

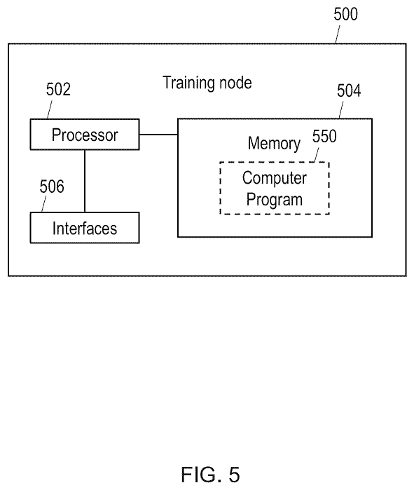

An example training node that may implement the methods disclosed herein as discussed above, for example on receipt of suitable instructions from a computer program, is illustrated in FIG. 5. The example training node comprises a processor or processing circuitry 502, and may comprise a memory 504 and interfaces 506. The processing circuitry 502 is operable to perform some or all of the steps of the methods 100 and/or 200 disclosed herein. The memory 504 may contain instructions executable by the processing circuitry 502 such that the example training node is operable to perform some or all of the steps of the methods 100 and/or 200 disclosed herein. The instructions may also include instructions for executing one or more telecommunications and/or data communications protocols. The instructions may be stored in the form of the computer program. In some examples, the processor or processing circuitry 502 may include one or more microprocessors or microcontrollers, as well as other digital hardware, which may include digital signal processors (DSPs), special-purpose digital logic, etc. The processor or processing circuitry may be implemented by any type of integrated circuit, such as an Application Specific Integrated Circuit (ASIC), Field Programmable Gate Array (FPGA) etc. The memory may include one or several types of memory suitable for the processor, such as read-only memory (ROM), random-access memory, cache memory, flash memory devices, optical storage devices, solid state disk, hard disk drive, etc.

As discussed above, the methods 300 and 400 presented herein may be performed by an image processing node, and the present disclosure provides an image processing node that is adapted to perform any or all of the steps of the above discussed methods. The image processing node may comprise a physical or virtual node, and may be implemented in a computer system, treatment apparatus, such as a radiotherapy treatment apparatus, computing device, or server apparatus, and/or may be implemented in a virtualized environment, for example in a cloud, edge cloud, or fog deployment. Examples of a virtual node may include a piece of software or computer program, a code fragment operable to implement a computer program, a virtualised function, or any other logical entity. The image processing node may encompass multiple logical entities, as discussed in greater detail below.

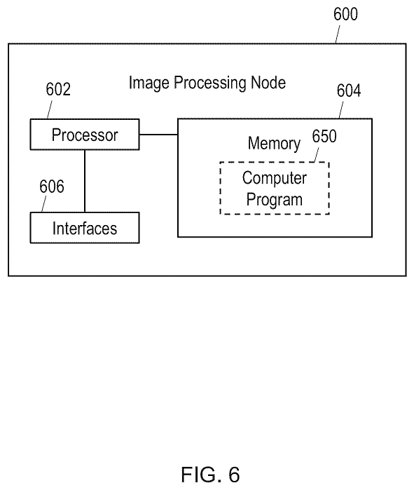

An example image processing node that may implement the methods disclosed herein as discussed above, for example on receipt of suitable instructions from a computer program, is illustrated in FIG. 6. The example image processing node comprises a processor or processing circuitry 602, and may comprise a memory 604 and interfaces 606. The processing circuitry 602 is operable to perform some or all of the steps of the methods 300 and/or 400 disclosed herein. The memory 604 may contain instructions executable by the processing circuitry 602 such that the example training node is operable to perform some or all of the steps of the methods 300 and/or 400 disclosed herein. The instructions may also include instructions for executing one or more telecommunications and/or data communications protocols. The instructions may be stored in the form of the computer program. In some examples, the processor or processing circuitry 602 may include one or more microprocessors or microcontrollers, as well as other digital hardware, which may include digital signal processors (DSPs), special-purpose digital logic, etc. The processor or processing circuitry may be implemented by any type of integrated circuit, such as an Application Specific Integrated Circuit (ASIC), Field Programmable Gate Array (FPGA) etc. The memory may include one or several types of memory suitable for the processor, such as read-only memory (ROM), random-access memory, cache memory, flash memory devices, optical storage devices, solid state disk, hard disk drive, etc.

In some examples as discussed above, the example training node 500 and/or the example image processing node 600 may be incorporated into treatment apparatus, and examples of the present disclosure also provide a radiotherapy treatment apparatus comprising one or more of a training node 500 as discussed above and/or an image processing node 600 as discussed above, and/or a treatment planning node operable to implement a method for adapting a radiotherapy treatment plan.

The above discussion provides an overview of methods which may be performed according to different examples of the present disclosure. These methods may be performed by a training node and image processing node respectively.

There now follows a detailed discussion of how different process steps illustrated and discussed above may be implemented in an example architecture called Geometric Neural Processes (GeomNP), as well as a mathematical treatment of the method steps described above. As an implementation of the methods disclosed herein, GeomNP is a probabilistic neural radiance field that explicitly captures uncertainty. The functionality and implementation detail described below is discussed with reference to the modules of the training and image processing nodes performing the methods substantially as described above. It will be appreciated that GeomNP is disclosed below in the context of non-medical images. This is for the purposes of illustration only, and the experimental validation takes advantage of the many available non-medical datasets. It will be appreciated that the implementation detail below may be adapted for medical images according to the methods presented herein. For example, where reference is made to image colour and density, it will be appreciated that medical images have a corresponding attenuation coefficient, which is representative of tissue density of the imaged anatomy.

The following notation is used throughout the remainder of the present disclosure.

3D world coordinates are denoted by p=(x, y, z) and the camera viewing direction by d=(θ, φ). Points in 3D space have color c(p, d), which depends on the location p and viewing direction d. Points also have a density value σ(p) that encodes opacity. Coordinates and view direction are represented together as x={p, d}, color and density together as y(p, d)={c(p, d), σ(p)}. When examining a 3D object from multiple locations, all 3D points are denoted as

$$X = {\{ {x}_{n} \}}_{n = 1}^{N}$$

and their colors and densities as

$$Y = {\{ {y}_{n} \}}_{n = 1}^{N} .$$

Assuming a ray r=(o, d) starting from the camera origin o and along direction d, P points are sampled along the ray, with

$${x}^{r} = {\{ {x}_{i}^{r} \}}_{i = 1}^{P}$$

and corresponding colors and densities

$${y}^{r} = {\{ {y}_{i}^{r} \}}_{i = 1}^{P} .$$

Further, the observations \tilde{X} and \tilde{Y} are denoted as: the set of camera rays

$$\tilde{X} = {\{ {\tilde{x}}_{n} = {r}_{n} \}}_{n = 1}^{N}$$

and the projected 2D pixels from the rays

$$\tilde{Y} = {\{ {\tilde{y}}_{n} \}}_{n = 1}^{N} .$$

Neural Radiance Field (NeRF) is formally described as a continuous function ƒ_{NeRF}:x [symbol] y, which maps 3D world coordinates p and viewing directions d to color and density [symbol] values y. That is, a NeRF function, ƒ_{NeRF}, is a neural network-based function that represents the whole 3D object as coordinates to color and density (or attenuation coefficient) mappings. Learning a NeRF function of a 3D object is an inverse problem in which only indirect observations of arbitrary 2D views of the 3D object are available, and it is desired to infer the entire 3D object's geometry and appearance.

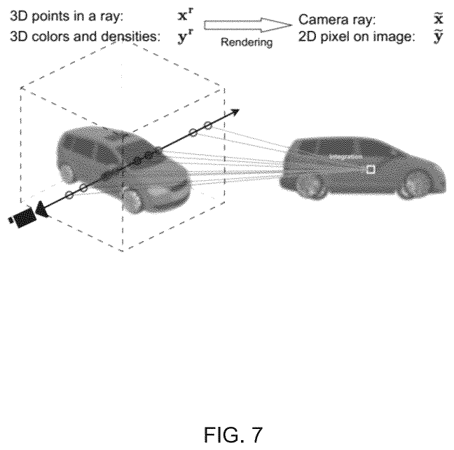

With the NeRF function, given any camera pose, it is possible to render a view on the corresponding 2D image plane by marching rays and using the corresponding colors and densities at the 3D points along the rays. Specifically, given a set of rays r with view directions d, a corresponding 2D image is obtained. The integration along each ray corresponds to a specific pixel on the 2D image using the volume rendering technique illustrated in FIG. 7. Details about the integration can be found in the “Additional Information” section at the end of this disclosure.

Neural Radiance Fields are normally considered as an optimization routine in a deterministic setting, whereby the function ƒ_{NeRF} fits specifically to the available observations (akin to “overfitting” training data). To allow for learning, however, examples of the present disclosure formulate a probabilistic Neural Radiance Field with the following factorization:

$$p ( \tilde{Y} \vert \tilde{X} ) ∝ p ( \tilde{Y} \vert Y , X ) ( Integration ) \times p ( Y \vert X ) ( NeRF Model ) \times p ( X \vert \tilde{X} ) ( Sampling ) \qquad Equation 1$$

The generation process of this probabilistic formulation is as follows, and starts from (or samples) a set of rays \tilde{X}. Conditioning on these rays, 3D points in space are sampled X|\tilde{X}. Then, these 3D points are mapped into their colors and density values (or attenuation coefficients) with the NeRF function, Y=ƒ_{NeRF}(X). Last, the 2D pixels of the viewing image that corresponds to the 3D ray \tilde{Y}|Y, X are sampled with a probabilistic process. This corresponds to integrating colors and densities Y along the ray on locations X.

The probabilistic model in Equation 1 is for a single 3D object, thus requiring optimizing a function ƒ_{NeRF} afresh for every new object, which is time-consuming. For NeRF generalization, learning is accelerated and generalization improved by amortizing the probabilistic model over multiple objects, obtaining per-object reconstructions by conditioning on context sets \tilde{X}_{C}, \tilde{Y}_{C}. For clarity, (⋅)_{C} is used to indicate context sets with a few new observations for a new object, while (⋅)_{T} indicates target sets containing 3D points or camera rays from novel views of the same object. Thus, a probabilistic NeRF for generalization is formulated as:

$$p ( {\tilde{Y}}_{T} \vert {\tilde{X}}_{T} , {\tilde{X}}_{C} , {\tilde{Y}}_{C} ) ∝ p ( {\tilde{Y}}_{T} \vert {Y}_{T} , {X}_{T} ) ( Integration ) \times p ( {Y}_{T} \vert {X}_{T} , {\tilde{X}}_{C} , {\tilde{Y}}_{C} ) ( NeRF Generalization ) \times p ( {X}_{T} \vert {\tilde{X}}_{T} ) ( Sampling ) \qquad Equation 2$$

As this disclosure focuses on generalization with new 3D objects, the same sampling and integrating processes are maintained as in Equation 1. Next is considered the modeling of the predictive distribution p(Y_{T}|X_{T}, \tilde{X}_{C}, \tilde{Y}_{C}) in the generalization step, which implies inferring the NeRF function. It will be appreciated that the predictive distribution in 3D space is conditioned on 2D context pixels with their ray {\tilde{X}_{C}, \tilde{Y}_{C}} and 3D target points X_{T}, which is challenging due to potential information misalignment. Thus, examples of the present disclosure propose the use of strong inductive biases with 3D structure information to ensure that 2D and 3D conditional information is fused reliably.

### Geometric Bases (Generated at Steps 120, 130, 220, 230, 320, 420 of Methods 100 to 400)

To mitigate the information misalignment between 2D context views and 3D target points, geometric bases

$${B}_{C} = {\{ {b}_{i} \}}_{i = 1}^{M}$$

are generated. The geometric bases induce prior structure to the context set {\tilde{X}_{C}, \tilde{Y}_{C}} geometrically. M is the number of geometric bases.

Each geometric basis consists of a Gaussian distribution in the 3D point space and a semantic representation, i.e bᵢ={ [symbol] (μᵢ, Σᵢ); ωᵢ} where μᵢ and Σᵢ are the mean and covariance matrix of i-th Gaussian in 3D space, and ωᵢ is its corresponding latent representation. Intuitively, the mixture of all 3D Gaussian distributions implies the structure of the object, while ωᵢ stores the corresponding semantic information. In practice, in the example implementation, a transformer-based encoder is used to learn the Gaussian distributions and representations from the context sets, i.e., {(μᵢ, Σᵢ, ωᵢ)}=Encoder[\tilde{X}_{C}, \tilde{Y}_{C}c]. Detailed architecture of the encoder is provided in the “Additional Information” section.

With the geometric bases B_{C}, the predictive distribution may be reviewed from p(Y_{T}|X_{T}, \tilde{X}_{C}, \tilde{Y}_{C}) to p(Y_{T}|X_{T}, B_{C}). By inferring the function distribution p(ƒ_{NeRF}), the predictive distribution may be reformulated as:

$$p ( {Y}_{T} \vert {X}_{T} , {B}_{C} ) = \int p ( {Y}_{T} \vert {f}_{N e R F} , {X}_{T} ) p ( {f}_{N e R F} \vert {X}_{T} , {B}_{C} ) d {f}_{N e R F} \qquad Equation 3$$

where p(ƒ_{NeRF}|X_{T}, B_{C}) is the prior distribution of the NeRF function, and p(Y_{T}|ƒ_{NeRF}, X_{T}) is the likelihood term. The prior distribution of the NeRF function is conditioned on the target points X_{T} and the geometric bases B_{C}. Thus, the prior distribution is data-dependent on the target inputs, yielding a better generalization on novel target views of new objects. Moreover, as B_{C} is constructed with continuous Gaussian distributions in the 3D space, the geometric bases can enrich the locality and semantic information of each discrete target point, enhancing the capture of high-frequency details.
Geometric Neural Processes with Hierarchical Latent Variables (Generated in Steps 140, 150, 240, 250, 330, 430 of Methods 100 to 400)

Using the geometric bases, Geometric Neural Processes (GeomNP) are generated by inferring the NeRF function distribution p(ƒ_{NeRF}|X_{T}, B_{C}) in a probabilistic way. Based on the probabilistic NeRF generalization in Equation 2, hierarchical latent variables are introduced to encode various spatial-specific information into p(ƒ_{NeRF}|X_{T}, B_{C}), improving the generalization ability in different spatial levels. Since all rays are independent of each other, the predictive distribution in Equation 3 can be decomposed as:

$$p ( {Y}_{T} \vert {X}_{T} , {B}_{C} ) = {\prod }_{n = 1}^{N} p ( {y}_{T}^{r , n} \vert {x}_{T}^{r , n} , {B}_{C} ) . \qquad Equation 4$$

where the target input X_{T} consists of N×P location points

$${\{ {x}_{T}^{r , n} \}}_{n = 1}^{N}$$

for N rays.

Further, a hierarchical Bayes framework may be developed for GeomNP to accommodate the data structure of the target input X_{T} in equation 4. An object-specific latent variable zₒ and N individual ray-specific latent variables

$${\{ {z}_{r}^{n} \}}_{n = 1}^{N}$$

are introduced to represent the randomness of ƒ_{NeRF}.

Within the hierarchical Bayes framework, zₒ encodes the entire object information from all target inputs and the geometric bases {X_{T}, B_{C}} in the global level; while every

$${z}_{r}^{n}$$

encodes ray-specific information from

$$\{ {x}_{T}^{r , n} , {B}_{C} \}$$

in the local level, which is also conditioned on the global latent variable zₒ. The hierarchical architecture allows the model to exploit the structure information from the geometric bases B_{C} in different levels, improving the model's expressiveness ability. By introducing the hierarchical latent variables in Equation 4, GeomNP may be modelled as:

$$p ( {Y}_{T} \vert {X}_{T} , {B}_{C} ) = \int p ( \text{} {z}_{o} \vert \text{} {X}_{T} , \text{} {B}_{c} ) \\ \text{} {\prod }_{n = 1}^{N} \{ \int p ( {z}_{r}^{n} \vert {z}_{o} , {x}_{T}^{r , n} , {B}_{C} ) p ( {y}_{T}^{r , n} \vert {x}_{T}^{r , n} , {B}_{C} , {z}_{r}^{n} , {z}_{o} ) {dz}_{r}^{n} \} {dz}_{o} . \qquad Equation 5$$

$$where$$

$$p ( {y}_{T}^{r , n} \vert {x}_{T}^{r , n} , {B}_{C} , {z}_{r}^{i} , {z}_{o} )$$

denotes the ray-specific likelihood term. In this term, the hierarchical latent variables

$$\{ {z}_{r}^{i} , {z}_{o} \}$$

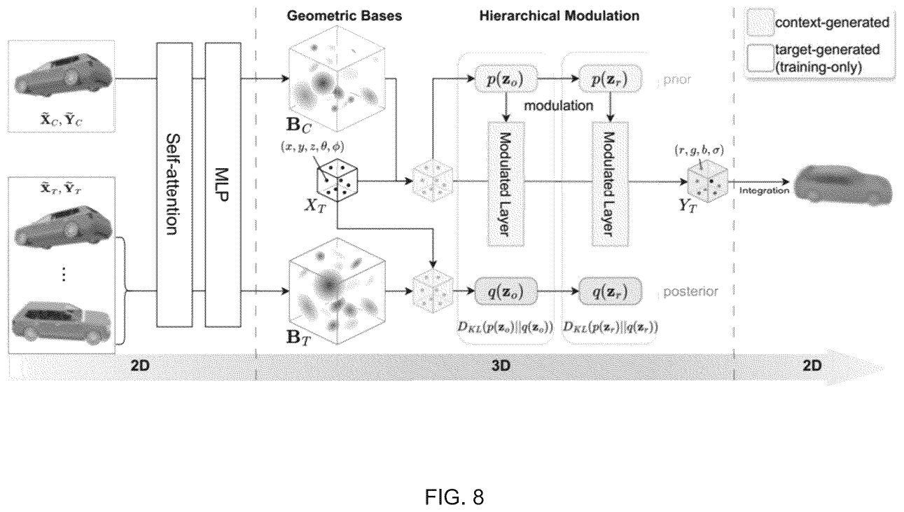

are used to modulate a ray-specific NeRF function ƒ_{NeRF} for prediction, as shown in FIG. 8 (steps 160, 260, 340, 340 of methods 100 to 400). Hence, ƒ_{NeRF} can explore global information of the entire object and local information of each specific ray, leading to better generalization ability on new scenes and new views.

FIG. 8 provides an illustration of the Geometric Neural Processes implementation of the methods disclosed herein, with radiance field generalization cast as a probabilistic modeling problem. Specifically, geometric bases B_{C} are first constructed in 3D space from the 2D context sets {\tilde{X}_{C}, \tilde{Y}_{C}} to model the 3D NeRF function (step 120, 220, 230, 420). The NeRF function is then inferred by modulating a shared MLP (steps 160, 260, 340, 440) through hierarchical latent variables zₒ, zᵣ and make predictions by the modulated MLP (steps 170, 270, 450a-c). The posterior distributions of the latent variables (steps 150, 250) are inferred from the target sets {\tilde{X}_{T}, \tilde{Y}_{T}}, which supervise the priors during training (steps 180, 280, 280a-c).

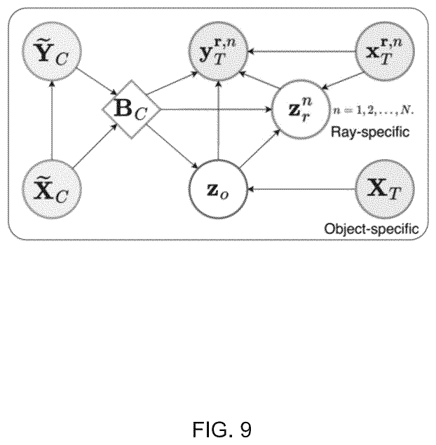

A graphical model of the geometric neural process is schematically represented in FIG. 9.

In the modeling of GeomNP, the prior distribution of each hierarchical latent variable is conditioned on the geometric bases and target input (step 240b). Each target location is first represented by integrating the geometric bases, i.e.,

$$〈 {x}_{T}^{n} , {B}_{C} 〉 ,$$

which aggregates the relevant locality and semantic information for the given input. Since B_{C} contains M Gaussians, a Gaussian radial basis function may be employed in Equation 6 between each target input

$${x}_{T}^{n}$$

and each geometric basis bᵢ to aggregate the structural and semantic information to the 3D location representation. Thus, the 3D location representation is obtained as follows:

$$〈 {x}_{T}^{n} , {B}_{C} 〉 = M L P [ {\sum }_{i = 1}^{M} exp ( - 1 / 2 {( {x}_{T}^{n} - {μ}_{i} )}^{T} {Σ}_{i}^{- 1} ( {x}_{T}^{n} - {μ}_{i} ) ) \cdot {ω}_{i} ] \qquad Equation 6$$

where MLP[⋅] is a learnable neural network. With the location representation

$$〈 {x}_{T}^{n} , {B}_{C} 〉 = MLP [ {\sum }_{i = 1}^{M} exp ( - 1 / 2 {( {x}_{T}^{n} - {μ}_{i} )}^{⊤} {Σ}_{i}^{- 1} ( {x}_{T}^{n} - {μ}_{i} ) ) \cdot {ω}_{i} ] \qquad Equation 6$$

each latent variable is next infered hierarchically, in object and ray levels.

Object-specific Latent Variable. The distribution of the object-specific latent variable zₒ is obtained by aggregating all location representations:

$$[ {μ}_{o} , {σ}_{o} ] = M L P [ \frac{1}{N \times P} {\sum }_{n = 1}^{N} {\sum }_{r} 〈 {x}_{T}^{n} , {B}_{C} 〉 ] \qquad Equation 7$$

where it is assumed that p(zₒ|B_{C}, X_{T}) is a standard Gaussian distribution and its mean μₒ and variance σₒ are generated by an MLP. Thus, the model captures objective-specific uncertainty in the NeRF function.

Ray-specific Latent Variable. To generate the distribution of the ray-specific latent variable, the location representations are first averaged ray-wisely. the ray-specific latent variable is then obtained by aggregating the averaged location representation and the object latent variable through a lightweight transformer. The inference of the ray-specific latent variable is formulated as:

$$[ {μ}_{r} , {σ}_{r} ] = Transformer ( MLP [ \frac{1}{P} {\sum }_{r} 〈 {x}_{T}^{n} , {B}_{C} 〉 ] ; {\hat{z}}_{o} ) \qquad Equation 8$$

where \hat{z}ₒ is a sample from the prior distribution p(zₒ|X_{T}, B_{C}). Similar to the object-specific latent variable, it is also assumed that the distribution

$$p ( {z}_{r}^{n} \vert {z}_{o} , {x}_{T}^{r , n} {B}_{C} , )$$

is a mean-field Gaussian distribution with the mean μᵣ and variance σᵣ. More details of the latent variables are provided in the “Additional Information” section.

NeRF Function Modulation. With the hierarchical latent variables

$$\{ {z}_{r}^{n} , {z}_{o} \} ,$$

a neural network is modulated for a 3D object in both object-specific and ray-specific levels. Specifically, the modulation of each layer is achieved by scaling its weight matrix with a style vector. The object-specific latent variable zₒ and ray-specific latent variable

$${z}_{r}^{n}$$

are taken as style vectors of the low-level layers and high-level layers, respectively. The prediction distribution p(Y_{T}|X_{T}, B_{C}) is finally obtained by passing each location representation through the modulated neural network for the NeRF function. More details are provided in the “Additional Information” section.

### Empirical Objective

Evidence Lower Bound. To optimize the proposed GeomNP, variational inference is applied, and the evidence lower bound (ELBO) is derived as:

$$log p ( {Y}_{T} \vert {X}_{T} , {B}_{C} ) \geq {𝔼}_{q ( {z}_{o} \vert {B}_{T} , {X}_{T} )} \{ {\sum }_{n = 1}^{N} {𝔼}_{q ( {z}_{r}^{n} \vert {z}_{o} , {x}_{T}^{r , n} , {B}_{T} )} log p ( {y}_{T}^{r , n} \vert {x}_{T}^{r , n} , {z}_{o} , {z}_{r}^{n} ) - {D}_{K L} [ \text{} q ( {z}_{r}^{n} \vert {z}_{o} , {x}_{T}^{r , n} , {B}_{T} ) ‖ p ( {z}_{r}^{n} \vert {z}_{o} , {x}_{T}^{r , n} , {B}_{C} ) ] \} - {D}_{K L} [ q ( {z}_{o} \vert {B}_{T} , {X}_{T} ) ‖ p ( {z}_{o} \vert {B}_{C} , T ) ] . \\ where {q}_{θ , ϕ} ( {z}_{o} , {\{ {z}_{r}^{i} \}}_{i = 1}^{N} \vert {X}_{T} , {B}_{T} ) = {Π}_{i = 1}^{N} q ( {z}_{r}^{n} \vert {z}_{o} , {X}_{T}^{r , n} , {B}_{T} ) q ( {z}_{o} \vert {B}_{T} , {X}_{T} )$$

is the involved variational posterior for the hierarchical latent variables. B_{T} is the geometric bases constructed from the target sets {\tilde{X}_{T}, \tilde{Y}_{T}}}, which are only accessible during training (methods 100, 200). The variational posteriors are inferred from the target sets during training, which introduces more information on the object. The prior distributions are supervised by the variational posterior using Kullback-Leibler (KL) divergence (steps 280, 280a, 280c), learning to model more object information with limited context data and generalize to new scenes. Detailed derivations are provided in the “Additional Information” Section.

For the geometric bases B_{C}, the spatial shape of the context geometric bases is regularized to be closer to that of the target one B_{T} by introducing a KL divergence. Therefore, given the above ELBO, the objective function consists of three parts: a reconstruction loss (MSE loss), KL divergences for hierarchical latent variables, and a KL divergence for the geometric bases. The empirical objective for the proposed GeomNP is formulated as:

$${L}_{GeomNP} = {‖ y - {y}^{′} ‖}_{2}^{2} + α \cdot ( {D}_{K L} [ p ( {z}_{o} \vert {B}_{C} ) \vert q ( {z}_{o} \vert {B}_{T} ) ] + {D}_{K L} [ p ( {z}_{r} \vert {z}_{o} , {B}_{C} ) \vert q ( {z}_{r} \vert {z}_{o} , {B}_{T} ) ] + β \cdot {D}_{K L} [ {B}_{C} , {B}_{T} ] \qquad Equation 10$$

Where y′ is the prediction. α and β are hyperparameters to balance the three parts of the objective. The KL divergence on B_{C}, B_{T} is to align the spatial location and the shape of two sets of bases.

### Experiments

Baselines. GeomNP was compared with three recent probabilistic INR generalization methods: NeRF-VAE, PONP and VNP on ShapeNet novel view synthesis and image regression tasks. PONP and VNP also rely on Neural Processes, however, they neglect structure information and the probabilistic interaction between 3D functions and 2D partial observations. Additionally, two previous well-known deterministic INR generalization approaches, LearnInit and TransINR, were chosen as baselines. Moreover, to demonstrate the flexibility of the proposed methods and their ability to handle real-world scenes, GeomNP was integrated with pixelNeRF and experiments were conducted on the DTU dataset.

### Novel View Synthesis

ShapeNet Setup. A 3D novel view synthesis task was performed on ShapeNet objects. Following previous works' setup, the dataset consisted of objects from three ShapeNet categories: chairs, cars, and lamps. For each 3D object, 25 views of size 128×128 images were generated from viewpoints randomly selected on a sphere. The objects in each category were divided into training and testing sets, with each training object consisting of 25 views with known camera poses. At test time, a random input view was sampled to evaluate the performance of the novel view synthesis. Following the setting of previous methods, the experiments focused on the single-view (1-shot) and 2-view (2-shot) versions of the task, with one or two images with their corresponding camera rays provided as the context.

Implementation Details. The context input was the concatenation of a set of camera rays and the corresponding image pixels from one or two views, which were then split into different visual tokens. The same patch size of 8×8 was used as in TransINR and VNP, resulting in 256 tokens. A linear layer and a self-attention module project each token into a 512-dimensional vector. Based on the 256 tokens, 256 geometric bases are predicted using two MLP modules: one for 3D Gaussian distribution parameters and the other for the latent representation (32 dimensions). More details are given in the “Additional Information” section. The object-specific and ray-specific modulating vectors (both are 512 dimensions) are obtained based on the geometric bases. The NeRF function consisted of four layers, including two modulated layers and two shared layers.

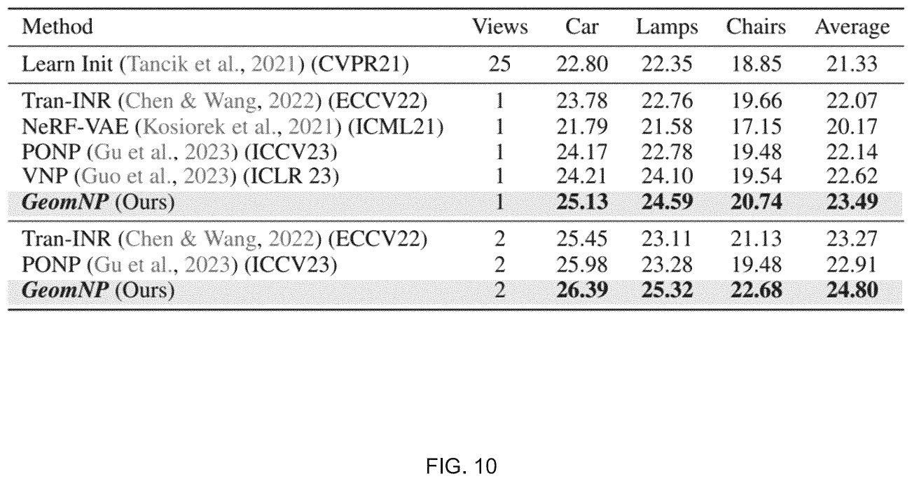

Quantitative Results. The quantitative comparison in terms of Peak Signal-to-Noise Ratio (PSNR) is presented in Table 1 (FIG. 10). GeomNP consistently outperforms all other baselines across all three categories by a significant margin. On average, GeomNP exceeds the previous NP-based method, VNP, by 0.87 PSNR, indicating that the proposed geometric bases and probabilistic hierarchical modulation result in better generalization ability. Moreover, with two views of context information, GeomNP's performance improves significantly by around 1 PSNR. This improvement is expected, as the richer geometric bases information allows for a better representation of the 3D space, leading to improved object-specific and ray-specific latent variables.

Qualitative Results. GeomNP is shown to infer object-specific radiance fields and render high-quality 2D images of the objects from novel camera views, even with only 1 or 2 views as context.

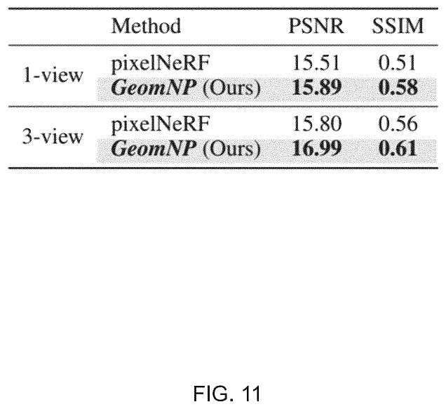

Comparison on DTU. To ensure a fair comparison with pixelNeRF using the same encoder and NeRF network architecture, the probabilistic framework of the present disclosure was incorporated into pixelNeRF. Experiments were conducted on real-world scenes from the DTU MVS dataset. To explore the capability of dealing with extremely limited context information, both models were trained with 1-view context, and the 1-view and 3-view results were tested in terms of PSNR and SSIM metrics. Both qualitative results in Table 2 (FIG. 11) and qualitative results demonstrate that the probabilistic modeling of the present disclosure can improve the existing methods. Notably, even when trained with a 1-view context image and tested with 3-view context images, the method of the present disclosure significantly outperforms pixelNeRF, demonstrating that the probabilistic framework utilizes limited observations in an effective manner.

### Ablations

Sensitivity to Number of Geometric Bases. The sensitivity to the number of geometric bases was analyzed using the Lamps NeRF task. The same setup was maintained as described above and tested with construction of 10, and then 250 bases. The results are provided below:

| | NeRF | NeRF |
|---|---|---|
| # Bases | 100 | 250 |
| PSNR | 24.31 | 24.59 |

With more bases, GeomNP achieves better consistently performance, indicating that large numbers of geometric Gaussian bases further enrich the structure information and lead to stronger predictive functions. The number of bases can be chosen by balancing the performance and computational costs.

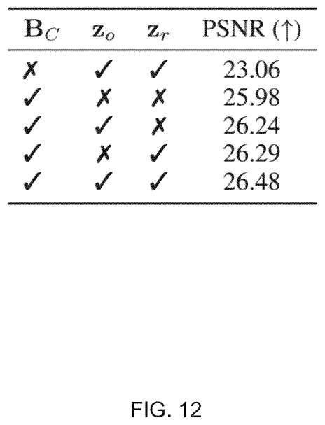

Importance of Hierarchical Latent Variables. To demonstrate the effectiveness of the hierarchical nature of GeomNP with object-specific and ray-specific latent variables for modulation, an ablation study was performed on a subset of the Lamps dataset for fast evaluation. As shown in the last four rows in Table 3 (FIG. 12), either object-specific or ray-specific latent variable improves the performance of neural processes, indicating the effectiveness of the specific function modulation. With both zₒ and zᵣ, the method performs best, demonstrating the importance of the hierarchical modulation by latent variables. In addition, the hierarchical modulation also performs well without the geometric bases. (In Table 3, a tick and cross demote whether the component joins the pipeline or not).

Importance of Geometric Bases. The effectiveness of the proposed geometric bases was also explored. As shown in Table 3 (rows 1 and 5), with the geometric bases, GeomNP performs clearly better. This indicates the importance of the 3D structure information modeled in the geometric bases, which provide specific inferences of the INR function in different spatial levels. Moreover, the bases perform well without hierarchical latent variables, demonstrating their ability to construct 3D information and reduce misalignment between 2D and 3D spaces.

Uncertainty Visualization. As a probabilistic framework, the methods proposed herein can provide uncertainty estimation. To obtain the uncertainty map, the predicted prior distribution may be sampled from ten times to generate corresponding images and then the variance map may be used to represent the uncertainty. High uncertainty is concentrated around the edges, which is expected, as capturing detailed, sharp changes at the edges is more challenging for the model.

Examples of the present disclosure thus provide INR generalization, in which models adapt efficiently to new signals with few observations. Specifically, the present disclosure proposes probabilistic neural radiance fields to explicitly capture uncertainty. INR generalization is formulated in a probabilistic manner, which incorporates uncertainty and directly infers the INR function distributions on limited context observations. To alleviate the information misalignment between the 2D context image and 3D discrete points in INR generalization, a set of geometric bases is introduced. The geometric bases learn to provide 3D structure information for inferring the INR function distributions. Hierarchical latent variables are then generated based on the geometric bases. The latent variables integrate 3D information and enable both object-specific and ray-specific modulation of the INR function functions in different spatial levels, leading to better generalization to new images. Despite being designed for 3D tasks, methods proposed herein can apply to 2D INR generalization problems. Experiments on novel view synthesis of 3D ShapeNet and DTU scenes demonstrate the effectiveness of the methods proposed herein.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

### Additional Information

### Neural Radiance Field Rendering

The rendering function of NeRF is outlines as follows. A 5D neural radiance field represents a scene by specifying the volume density and the directional radiance emitted at every point in space. NeRF calculates the color of any ray traversing the scene based on principles from classical volume rendering. The volume density σ(x) quantifies the differential likelihood of a ray terminating at an infinitesimal particle located at x. The anticipated color C(r) of a camera ray r(t)=o+td, within the bounds tₙ and tᵣ, is determined as follows:

$$C ( r ) = {\int }_{{t}_{n}}^{{t}_{f}} T ( t ) σ ( r ( t ) ) c ( r ( t ) , d ) dt , where T ( t ) = exp ( - {\int }_{{t}_{n}}^{t} σ ( r ( s ) ) d s ) \qquad Equation 11$$

Here, the function T (t) represents the accumulated transmittance along the ray from tₙ to t, which is the probability that the ray travels from tₙ to t without encountering any other particles. To render a view from the continuous neural radiance field, it is necessary to compute this integral C(r) for a camera ray traced through each pixel of the desired virtual camera.

### Gaussian Construction

As discussed above, aspects of the present disclosure introduce geometric bases B_{C} to structure the context variables geometrically. B_{C} are geometric bases (Gaussians) inferred from the context views {\tilde{X}_{C}, \tilde{Y}_{C}} with 3D structure information, i.e

$${b}_{i} = \{ 𝒩 ( {μ}_{i} , {Σ}_{i} ) ; {w}_{i} \}$$

$${B}_{C} = {\{ {b}_{i} \}}_{i = 1}^{M} , {b}_{i} = \{ 𝒩 ( {μ}_{i} , {Σ}_{i} ) ; {w}_{i} \} \qquad Equation 12$$

$${μ}_{i} , {Σ}_{i} = A tt ( {\tilde{X}}_{C} , {\tilde{Y}}_{C} ) , A tt ( {\tilde{X}}_{C} , {\tilde{Y}}_{C} ) \qquad Equation 13$$

$${w}_{i} = Att ( {\tilde{X}}_{C} , {\tilde{Y}}_{C} ) \qquad Equation 14$$

where M is the number of the Gaussian bases. μ∈R³ is the Gaussian center, Σ∈R^{3×3} is the covariance matrix, and ω∈ [symbol] is the corresponding d_{B}-dimension semantic representation. In the present implementation, d_{B} is chosen as 32. Att is a self-attention module. Specifically, given the context set {\tilde{X}: \tilde{Y}}∈ [symbol] , the visual self-attention module, Att, first produces a M×D tokens with M is the number of visual tokens and D is the hidden dimension. The number of Gaussians used equals the number of tokens M. Then, one MLP with 2 linear layers is used to map the tokens into a 10-dimensional vector, which includes 3-dimensional Gaussian centers, a 3-dimensional vector for constructing the scaling matrix, and a 4-dimensional vector for quaternion parameters of the rotation matrix. Both the scaling matrix and rotation matrix are used to build the 3×3 covariance matrix. This procedure is similar to Gaussian construction in the 3D Gaussian Splatting. Another MLP estimates the latent representation of each Gaussian basis, using a 32-dimensional vector for each Gaussian basis.

The covariance matrix is obtained by:

$$Σ = R S {S}^{T} {R}^{T} \qquad Equation 15$$

where R∈ [symbol] is the rotation matrix, and S∈ [symbol] is the scaling matrix.

### Hierarchical Latent Variables

At the object level, the distribution of an object-specific latent variable zₒ is obtained by aggregating all location representations from (B_{C}, X_{T}). It is assumed p(zₒ|B_{C}, X_{T}) follows a standard Gaussian distribution and its mean μₒ and variance σₒ are generated using MLPs. An object-specific modulation vector, \hat{z}ₒ, is sampled from its prior distribution p(zₒ|X_{T}, B_{C}).

Similarly the information per ray is aggregated using B_{C}, which is then fed into a Transformer along with \hat{z}ₒ to predict the latent variable zᵣ with mean μᵣ and σᵣ for each ray.

### Modulation

The latent variables for modulating the MLP are represented as [zₒ:zᵣ]. The proposed approach to the modulated MLP layer follows the style modulation techniques described in (Karras et al., 2020; Guo et al., 2023). Specifically, the weights of an MLP layer (or 1×1 convolution) are considered as W∈ [symbol] , where dᵢₙ and dₒᵤₜ are the input and output dimensions respectively, and w_{i,j} is the element at the i-th row and j-th column of W.

To generate the style vector S∈ [symbol] , we pass the latent variable z through two MLP layers. Each element sᵢ of the style vector s is then used to modulate the corresponding parameter in W.

$$\begin{matrix}{w}_{i j}^{′} = {s}_{i} \cdot {w}_{i j} , & j\end{matrix} = 1 , … , {d}_{o u t} \qquad Equation 16$$

Where wᵢⱼ and w′ₜⱼ denote the original and modulated weights respectively. The modulated weights are normalized to preserve training stability.

$${w}_{i j}^{″} = \frac{{w}_{i j}^{′}}{\sqrt{{Σ}_{i} {{w}_{i j}^{′}}^{2} + ε}} , j = 1 , … , {d}_{o u t} \qquad Equation 17$$

### Derivation of Evidence Lower Bound

The proposed GeomNP is formulated as:

$$p ( {Y}_{T} \vert {X}_{T} , {B}_{c} ) = \int {\prod }_{n = 1}^{N} \{ \int p ( {y}_{T}^{r , n} \vert {x}_{T}^{r ,} , {B}_{C} , {z}_{r}^{n} , {z}_{o} ) p ( {r}^{n} \vert {z}_{o} , {x}_{T}^{r , n} , {B}_{C} ) d {z}_{r}^{n} \} p ( {z}_{o} \vert {X}_{T} , {B}_{C} ) d {z}_{o} \\ where p ( {z}_{o} \vert {B}_{C} , {X}_{T} ) p ( {z}_{r}^{n} \vert {z}_{o} , {x}_{T}^{r , n} , {B}_{C} ) \qquad Equation 18$$

denote prior distributions of a object-specific and each ray specific latent variable, respectively. Then, the evidence lower bound is derived as follows.

$$log p ( {Y}_{T} \vert {X}_{T} , {B}_{c} ) = log \int {\prod }_{n = 1}^{N} \{ \int p ( {y}_{T}^{r , n} \vert {x}_{T}^{r , n} , {z}_{o} , {z}_{r}^{n} ) p ( {z}_{r}^{n} \vert {z}_{o} , {x}_{T}^{r , n} , {B}_{C} ) d {z}_{r}^{n} \} p ( {z}_{o} \vert {B}_{C} , {X}_{T} ) d {z}_{o} = log \int {\prod }_{n = 1}^{N} \{ \int p ( {y}_{T}^{r , n} \vert {x}_{T}^{r , n} , {z}_{o} , {z}_{r}^{n} ) p ( {z}_{r}^{n} \vert {z}_{o} , {x}_{T}^{r , n} , {B}_{C} ) \frac{q ( {z}_{r}^{n} \vert {z}_{o} , {x}_{T}^{r , n} , {B}_{T} )}{q ( {z}_{r}^{n} \vert {z}_{o} , {x}_{T}^{r , n} , {B}_{T} )} d {z}_{r}^{n} \} p ( {z}_{o} \vert {B}_{C} , {X}_{T} ) \frac{q ( {z}_{o} \vert {B}_{T} , {X}_{T} )}{q ( {z}_{o} \vert {B}_{T} , {X}_{T} )} d {z}_{o} \geq {E}_{q} ( {z}_{o} \vert {B}_{T} , {X}_{T} ) \{ {\sum }_{n = 1}^{N} log \int p ( {y}_{T}^{r , n} \vert {x}_{T}^{r , n} , {z}_{o} , {z}_{r}^{n} ) p ( {z}_{r}^{n} \vert {z}_{o} , {x}_{T}^{r , n} , {B}_{C} ) \frac{q ( {z}_{r}^{n} \vert {z}_{o} , {x}_{T}^{r , n} , {B}_{T} )}{q ( {z}_{r}^{n} \vert {z}_{o} , {x}_{T}^{r , n} , {B}_{T} )} d {z}_{r}^{n} \} - {D}_{K L} ( q ( {z}_{o} \vert {B}_{T} , {X}_{T} ) ‖ p ( {z}_{o} \vert {B}_{C} , {X}_{T} ) ) \geq {E}_{q} ( {z}_{o} \vert {B}_{T} , {X}_{T} ) \{ {\sum }_{n = 1}^{N} {E}_{q} ( {z}_{r}^{n} \vert {z}_{o} , {x}_{T}^{r , n} , {B}_{T} ) log ( p ( {y}_{T}^{r , n} \vert {x}_{T}^{r , n} , {z}_{o} , {z}_{r}^{n} ) ) - {D}_{K L} [ q ( {z}_{r}^{n} \vert {z}_{o} , {x}_{T}^{r , n} , {B}_{T} ) ‖ p ( {z}_{r}^{n} \vert {z}_{o} , {x}_{T}^{r , n} , {B}_{C} ) ] \} - {D}_{K L} [ q ( {z}_{o} \vert {B}_{T} , {X}_{T} ) ‖ p ( {z}_{o} \vert {B}_{C} , {X}_{T} ) ] Where {q}_{θ , ϕ} ( {z}_{o} , {\{ {z}_{r}^{i} \}}_{i = 1}^{N} \vert {X}_{T} , {B}_{T} ) = q ( {z}_{r}^{n} \vert {z}_{o} , {x}_{T}^{r , n} , {B}_{T} ) q ( {z}_{o} \vert {B}_{T} , {X}_{T} ) \qquad Equation 19$$

is the variational posterior of the hierarchical latent variables.

### Training Details

All example implementation models discussed above were trained with PyTorch. Adam optimizer was used with a learning rate of 1e−4. For NeRF-related experiments, the models were trained for 1000 epochs. All experiments were conducted on four NVIDIA A5000 GPUs. The hyper-parameters α and β, were set as 0.001.

What is claimed is:

1. A computer implemented method for training a system to generate an Implicit Neural Representation (INR) of a 3-dimensional (3D) medical image, wherein the system comprises a first probabilistic Machine Learning (ML) module, a second probabilistic ML module, and a probabilistic Neural Radiance Field (NeRF) module, the method comprising:
obtaining a training dataset comprising, for individual training 3D medical images, a context set of ray paths and corresponding 2-dimensional (2D) projections of the image, and a target set of ray paths and corresponding 2D projections of the image, the target set comprising a greater number of ray paths and corresponding 2D projections of the image than the context set;
for individual training 3D medical images:
generating a plurality of context geometric bases using the first probabilistic ML module and the context set;
generating a plurality of target geometric bases using the first probabilistic ML module and the target set;
generating prior distributions of a set of latent variables using the second probabilistic ML module, the context geometric bases, and points sampled along ray paths sampled from the training 3D medical image; and
generating posterior distributions of the set of latent variables using the second probabilistic ML module, the target geometric bases, and the points sampled along ray paths sampled from the training 3D medical image;
modulating the probabilistic NeRF module using values sampled from the prior distributions of the set of latent variables;
using the modulated probabilistic NeRF module to predict attenuation coefficient values for points sampled along ray paths sampled from the training 3D medical image; and
updating trainable parameters of the first probabilistic ML module, second probabilistic ML module, and probabilistic NeRF module to minimize an objective function.

2. The method as claimed in claim 1, wherein the modulated probabilistic NeRF module is operable to predict an attenuation coefficient value as a function of an input comprising three dimensional spatial coordinates of a location for the prediction and a ray path direction for the prediction.

3. The method as claimed in claim 1, wherein the objective function comprises:
a reconstruction loss component;
a component of divergence between the context and target geometric bases; and
a component of divergences between the prior and posterior distributions of the set of latent variables.

4. The method as claimed in claim 3, wherein the reconstruction loss component comprises a measure of an error between the attenuation coefficient values for points sampled along ray paths sampled from the training 3D medical image predicted by the modulated probabilistic NeRF module, and corresponding attenuation coefficient values for the points extracted from the training 3D medical image.

5. The method as claimed in claim 3, wherein the divergence between the context and target geometric bases, and the divergences between the prior and posterior distributions of the set of latent variables are Kullback-Leibler divergences.

6. The method as claimed in claim 1, wherein the first probabilistic ML module comprises a self attention module and a Multi Layer Perceptron (MLP).

7. The method as claimed in claim 1, wherein the second probabilistic ML module comprises a transformer module and a Multi Layer Perceptron (MLP).

8. The method as claimed in claim 1, wherein the geometric bases comprise Gaussian distributions in 3D point space.

9. The method as claimed in claim 1, wherein generating the plurality of context geometric bases using the first probabilistic ML module and the context set comprises inputting the ray paths and corresponding 2D projections of the context set to the first probabilistic ML module, wherein the first probabilistic ML module is operable to process the ray paths and corresponding 2D projections in accordance with current values of its trainable parameters, and to output the plurality of context geometric bases.

10. The method as claimed in claim 1, wherein the set of latent variables is a hierarchical set.

11. The method as claimed in claim 1, wherein the set of latent variables comprises a global level latent variable and a plurality of local latent variables.

12. The method as claimed in claim 11, wherein the plurality of local latent variables comprise ray specific latent variables.

13. The method as claimed in claim 11, wherein generating prior distributions of the set of latent variables using the second probabilistic ML module, the context geometric bases, and points sampled along ray paths sampled from the training 3D medical image, comprises conditioning the plurality of local latent variables on the global latent variable.

14. The method as claimed in claim 11, wherein generating prior distributions of the global latent variable comprises using an MLP of the second probabilistic ML module with the context geometric bases and points sampled along ray paths sampled from the training 3D medical image.

15. The method as claimed in claim 11, wherein generating prior distributions of the local latent variables comprises using a transformer and MLP of the second probabilistic ML module with the context geometric bases, points sampled along ray paths sampled from the training 3D medical image, and the global latent variable.

16. The method as claimed in claim 11, wherein modulating the probabilistic NeRF module using values sampled from the prior distributions of the set of latent variables comprises scaling weight matrices of individual layers in the probabilistic NeRF module with a style vector based on values sampled from the prior distributions of the set of latent variables.

17. The method as claimed in claim 16, when dependent on claim 11, wherein modulating the probabilistic NeRF module using values sampled from the prior distributions of the set of latent variables comprises using the global latent variable as a style vector of one or more low-level layers of the probabilistic NeRF module, and the plurality of local latent variables as style vectors of high-level layers of the probabilistic NeRF module.

18. A computer implemented method for using a system to generate an Implicit Neural Representation, INR, of a 3-dimensional, 3D, medical image, wherein the system comprises a first probabilistic Machine Learning (ML) module, a second probabilistic ML module, and a probabilistic Neural Radiance Field (NeRF) module, the method comprising:
obtaining a context set of ray paths and corresponding 2-dimensional (2D) projections of the image;
generating a plurality of context geometric bases using the first probabilistic ML module and the context set;
generating prior distributions of a hierarchical set of latent variables using the second probabilistic ML module, the context geometric bases, and points sampled along ray paths sampled from the 3D medical image; and
modulating the probabilistic NeRF module using values sampled from the prior distributions of the hierarchical set of latent variables.

19. The method as claimed in claim 18, wherein the system is a trained system, and has been trained by:
obtaining a training dataset comprising, for individual training 3D medical images, a context set of ray paths and corresponding 2-dimensional (2D) projections of the image, and a target set of ray paths and corresponding 2D projections of the image, the target set comprising a greater number of ray paths and corresponding 2D projections of the image than the context set;
for individual training 3D medical images:
generating a plurality of context geometric bases using the first probabilistic ML module and the context set;
generating a plurality of target geometric bases using the first probabilistic ML module and the target set;
generating prior distributions of a set of latent variables using the second probabilistic ML module, the context geometric bases, and points sampled along ray paths sampled from the training 3D medical image; and
generating posterior distributions of the set of latent variables using the second probabilistic ML module, the target geometric bases, and the points sampled along ray paths sampled from the training 3D medical image;
modulating the probabilistic NeRF module using values sampled from the prior distributions of the set of latent variables;
using the modulated probabilistic NeRF module to predict attenuation coefficient values for points sampled along ray paths sampled from the training 3D medical image; and
updating trainable parameters of the first probabilistic ML module, second probabilistic ML module, and probabilistic NeRF module to minimize an objective function.

20. The method as claimed in claim 18, wherein the modulated probabilistic NeRF module is operable to predict an attenuation coefficient value as a function of an input comprising three dimensional spatial coordinates of a location for the prediction and a ray path direction for the prediction.

21. The method as claimed in claim 18, wherein the first probabilistic ML module comprises a self attention module and a Multi Layer Perceptron (MLP).

22. The method as claimed in claim 18, wherein the second probabilistic ML module comprises a transformer module and an MLP.

23. The method as claimed in claim 18, wherein the geometric bases comprise Gaussian distributions in 3D point space.

24. The method as claimed in claim 18, wherein generating the plurality of context geometric bases using the first probabilistic ML module and the context set comprises inputting the ray paths and corresponding 2D projections of the context set to the first probabilistic ML module, wherein the first probabilistic ML module is operable to process the ray paths and corresponding 2D projections in accordance with current values of its trainable parameters, and to output the plurality of context geometric bases.

25. The method as claimed in claim 18, wherein the set of latent variables is a hierarchical set.

26. The method as claimed in claim 18, wherein the set of latent variables comprises a global level latent variable and a plurality of local latent variables.

27. The method as claimed in claim 26, wherein the plurality of local latent variables comprise ray specific latent variables.

28. The method as claimed in claim 26, wherein generating prior distributions of the set of latent variables using the second probabilistic ML module, the context geometric bases, and points sampled along ray paths sampled from the 3D medical image, comprises conditioning the plurality of local latent variables on the global level latent variable.

29. The method as claimed in claim 26, wherein generating prior distributions of the global latent variable comprises using an MLP of the second probabilistic ML module with the context geometric bases and points sampled along ray paths sampled from the 3D medical image.

30. The method as claimed in claim 26, wherein generating prior distributions of the local latent variables comprises using a transformer and MLP of the second probabilistic ML module with the context geometric bases, points sampled along ray paths sampled from the 3D medical image, and the global latent variable.

31. The method as claimed in claim 26, wherein modulating the probabilistic NeRF module using values sampled from the prior distributions of the set of latent variables comprises scaling weight matrices of individual layers in the probabilistic NeRF module with a style vector based on values sampled from the prior distributions of the set of latent variables.

32. The method as claimed in claim 31, when dependent on claim 26, wherein modulating the probabilistic NeRF module using values sampled from the prior distributions of the set of latent variables comprises using the global latent variable as a style vector of one or more low-level layers of the probabilistic NeRF module, and the plurality of local latent variables as style vectors of high-level layers of the probabilistic NeRF module.

33. The method as claimed in claim 18, further comprising:
using the modulated probabilistic NeRF module to predict attenuation coefficient values for points sampled along ray paths through 3D medical image.

34. The method as claimed in claim 18, further comprising:
reconstructing the 3D medical image using predicted attenuation coefficient values from the modulated probabilistic NeRF module.

35. The method as claimed in claim 18, further comprising:
performing registration of the 3D medical image using predicted attenuation coefficient values from the modulated probabilistic NeRF module.

36. The method as claimed in claim 18, wherein the medical images comprise at least one of:
Computed Tomography (CT) images;
Cone Beam CT (CBCT) images; or
Magnetic Resonance Images.

37. A non-transitory computer-readable medium with instructions stored thereon, the instructions, when executed by a processor of a system comprising a first probabilistic Machine Learning (ML) module, a second probabilistic ML module, and a probabilistic Neural Radiance Field (NeRF) module, cause the processor to perform operations comprising:
obtaining a training dataset comprising, for individual training 3D medical images, a context set of ray paths and corresponding 2-dimensional (2D) projections of the image, and a target set of ray paths and corresponding 2D projections of the image, the target set comprising a greater number of ray paths and corresponding 2D projections of the image than the context set;
for individual training 3D medical images:
generating a plurality of context geometric bases using the first probabilistic ML module and the context set;
generating a plurality of target geometric bases using the first probabilistic ML module and the target set;
generating prior distributions of a set of latent variables using the second probabilistic ML module, the context geometric bases, and points sampled along ray paths sampled from the training 3D medical image; and
generating posterior distributions of the set of latent variables using the second probabilistic ML module, the target geometric bases, and the points sampled along ray paths sampled from the training 3D medical image;
modulating the probabilistic NeRF module using values sampled from the prior distributions of the set of latent variables;
using the modulated probabilistic NeRF module to predict attenuation coefficient values for points sampled along ray paths sampled from the training 3D medical image; and
updating trainable parameters of the first probabilistic ML module, second probabilistic ML module, and probabilistic NeRF module to minimize an objective function.

38. A training node for training a system to generate an Implicit Neural Representation (INR) of a 3-dimensional (3D) medical image, wherein the system comprises a first probabilistic Machine Learning (ML) module, a second probabilistic ML module, and a probabilistic Neural Radiance Field (NeRF) module, the training node comprising processing circuitry configured to cause the training node to:
obtain a training dataset comprising, for individual training 3D medical images, a context set of ray paths and corresponding 2-dimensional, 2D, projections of the image, and a target set of ray paths and corresponding 2D projections of the image, the target set comprising a greater number of ray paths and corresponding 2D projections of the image than the context set;
for individual training 3D medical images:
generate a plurality of context geometric bases using the first probabilistic ML module and the context set;
generate a plurality of target geometric bases using the first probabilistic ML module and the target set;
generate prior distributions of a set of latent variables using the second probabilistic ML module, the context geometric bases, and points sampled along ray paths sampled from the training 3D medical image; and
generate posterior distributions of the set of latent variables using the second probabilistic ML module, the target geometric bases, and the points sampled along ray paths sampled from the training 3D medical image;
modulate the probabilistic NeRF module using values sampled from the prior distributions of the set of latent variables;
use the modulated probabilistic NeRF module to predict attenuation coefficient values for points sampled along ray paths sampled from the training 3D medical image; and
update trainable parameters of the first probabilistic ML module, second probabilistic ML module, and probabilistic NeRF module to minimize an objective function.

39. The training node as claimed in claim 38, wherein the processing circuitry is further configured to cause the training node to predict an attenuation coefficient value as a function of an input comprising three dimensional spatial coordinates of a location for the prediction and a ray path direction for the prediction.

40. An image processing node for using a system to generate an Implicit Neural Representation (INR) of a 3-dimensional (3D) medical image, wherein the system comprises a first probabilistic Machine Learning (ML) module, a second probabilistic ML module, and a probabilistic Neural Radiance Field (NeRF) module, the image processing node comprising processing circuitry configured to cause the image processing node to:
obtain a context set of ray paths and corresponding 2-dimensional, 2D, projections of the image;
generate a plurality of context geometric bases using the first probabilistic ML module and the context set;
generate prior distributions of a hierarchical set of latent variables using the second probabilistic ML module, the context geometric bases, and points sampled along ray paths sampled from the 3D medical image; and
modulate the probabilistic NeRF module using values sampled from the prior distributions of the hierarchical set of latent variables.
